(19) United States
(12) Patent Application Publication
(10) Pub. No.: US 2009/0179113 A1
(43) Pub. Date: Jul. 16, 2009

(54) Method and apparatus for elevating and manipulating objects using electromagnetic fields only

(76) Inventor: William Redvers Belisle, New Orleans, LA (US)

Correspondence Address: WILLIAM REDVERS BELISLE, 7901 Lafourche St., New Orleans, LA, 70127, US

(21) Appl. No.: 11/827,433

(22) Filed: Jul. 11, 2007

Related U.S. Application Data
(63) Continuation-in-part of application No. 10/979,723, filed on Nov. 3, 2004, now abandoned.

(51) Int. Cl. B64G 1/24

(52) U.S. Cl. 244/166

(57) ABSTRACT

An electromagnetic field-producing device is used for non-contact type high elevation, elevation maintenance, or manipulation of objects. This type of elevation, elevation maintenance, or manipulation of objects contributes to the present modes of flight and people and larger object transport including but not limited to rotary-wing or non-rotary-wing modes of flying and mechanical/electronic modes of object movement.

### CROSS-REFERENCES TO RELATED APPLICATIONS

1. Linliu, Kung (Taipei, TW). 1999. ‘Metallization process using artificial gravity’.

2. Wing, Michael L., 1996. ‘Gravitational, magnetic, floating ball valve’.

3. Dulck, Jean F., 1996. ‘Satellite and method to place this satellite in orbit by gravitational assistance’.

4. Takeda, Tsunehiro, Endo, Hiroshi, and Kumagai, Toru, 1999. ‘Magnetic field source movable phantom head’.

5. Higuchi, Toshiro, Tsutsui, Yukio, Nogawa, Miyamae-ku, and Kawasaki-shi, Kanagawa, 1999. ‘Non-contact magnetic suspension apparatus using distortions of pinned superconductor field’.

6. De Wit, Deceased, et al. 1999. ‘Display device comprising a display tube having an external shield against the earth's magnetic field’.

7. Radhakrishnan, Gouri. 1999. ‘Magnetic field pulsed laser deposition of thin films’.

8. Bornhofft, et al. 1986. ‘Arrangement for remote sweeping of mines sensitive to magnetic fields’.

9. McDaniel, et al. 1980. ‘Apparatus for electromagnetically generating fields for repelling or attracting permanent magnetic fields for the purpose of entertainment’.

10. Sheridon, Necholas K. 1998. ‘Canted electric fields for addressing a twisting ball display’.

11. Criswell, David R. 1993. ‘Vehicle propulsion system with external propellant supply’.

12. Kare, Jordan T. 1992. ‘Reflector for efficient coupling of a laser beam to air or other fluids’.

13. Lovell, William V. 1946. ‘Electromagnet’.

14. Baker, Alfred V. et. al. 1967. ‘Control method and apparatus’.

15. Wipf, Stefan L. 1971. ‘Magnet suspension system’.

16. Coffey, Howard T. 1993. ‘Propulsion and stabilization system for magnetically levitated vehicles’.

17. Dolgin, Benjamin P. 1994. ‘Superconductive material and magnetic field for damping and levitating support and damping cryogenic instruments’.

18. Metz et al. 1985. ‘Lifting electromagnet’.

19. NASA website. “Maglev: Launching Rockets Using a Magnet.” Oct. 25, 1999. http://liftoff.msfc.nasa.gov/news/1999/newsmaglev.asp.

20. Eastern Illinois. The Magnetic Field. 2002. http://www.ux1.eiu.edu/˜cfadd/1360/29maqflds/magfid.html.

21. Alien Baby. “Forget Superconducting Maglevs.” 2000. http://alienbaby.com/levitron.html.

### STATEMENT REGARDING FEDERALLY SPONSORED RESEARCH AND DEVELOPMENT

Not Applicable

### REFERENCE TO A “MICROFICHE APPENDIX”

Not Applicable

### BACKGROUND OF INVENTION

1. Field of the Invention/Technical Field

The following is ‘A statement of the field of art to which the invention pertains’:

1. U.S. Class 438 Field of Search: 438/660

2. U.S. Class 604 Field of Search: 604/254

3. U.S. Class 244 Field of Search: 244/158R

4. U.S. Class 600 Field of Search: 600/409

5. U.S. Class 310 Field of Search: 310/90.5

6. U.S. Class 313 Field of Search: 313/402

7. U.S. Class 427 Field of Search: 427/571

8. U.S. Class 114 Field of Search: 114/312

9. U.S. Class 273 Field of Search: 273/345

10. U.S. Class 359 Field of Search: 359/296

11. U.S. Class 244 Field of Search: 244/1R

12. U.S. Class 60 Field of Search: 60/203.1

13. U.S. Class 335 Field of Search: 335/250

14. U.S. Class 361 Field of Search: 361/144

15. U.S. Class 104 Field of Search: 104/281

16. U.S. Class 104 Field of Search: 104/281

17. U.S. Class 335 Field of Search: 335/216

18. U.S. Class 361 Field of Search: 361/144

2. Description of the Related Art/Background Art

Present patents describe the use of gravity, magnetic, electrical, electromagnetic, or other artificial fields to remove voids in via (heated vias) holes in integrated circuits using magnetic repulsion (Linliu and Kung, 1999), to attract magnetic objects (Wing, 1996), and to maintain or connect satellite orbits about the moon with the assistance of the moon's gravitational pull (i.e. after the satellite has been placed in orbit . . . ) (Dulck, 1996). Patents for magnetic fields describe the use of such fields to move electrodes within closed vessels or tubes filled with a physiologic saline (Takeda, et al., 1999), to stably suspend in a non-contacting manner, by the combination of high temperature superconductor and a ferromagnetic member (Higuchi, et al., 1999), to at least compensate for the earth's magnetic field in at least two fields and an excitable coil to compensate for the component of the earth's magnetic field in the third direction (De Wit, et al., 1999), and to deflect charged species produced by a laser beam (Radhakrishnan, Gouri, 1999). McDaniel, et al. (1980) describe the use of magnetic fields to repel or attract permanent magnets in specially configured, non magnetic material as a part of a game used for entertainment purposes. Patents for magnetic fields also describe the use of magnetic fields to detect magnetic field mines (Bornhoffl and Irenkler, 1986).

Patents for electrical fields describe the use of electrical fields to align and rotate electrically and optically anisotropic spheroidal balls in a substrate (Sheridon, 1998). Criswell (1993) describes the use of lasers or electromagnetic fields to energize the propellant trail of a rocket for combustion. Kare (1992) describes the use of a focused (using focusing mirrors) laser or electromagnetic energy to break down air or other fluids creating plasma. The plasma, which has absorbed energy from the laser, grows in volume and provides thrust.

Coffey does not claim or include the elevation and sustaining the elevation of an object at a single x, y, z coordinate or position as does the present invention. Coffey claims or includes the motion of a vehicle at a given height only when the elevated vehicle is moving horizontally. In addition and regarding Coffey, the horizontal motion of the vehicle generates the vehicle elevation. The present invention claims or includes the elevation and sustaining the elevation of an object at a given x, y, z coordinate or position. The present invention does not claim or include the motion of a vehicle at a given height only when the elevated vehicle is moving horizontally. In the present invention, the horizontal motion of the vehicle does not generate the vehicle elevation.

Coffey claims a magnetic levitation and propulsion system for a vehicle adapted to travel over a roadbed. The present invention does not claim a magnetic levitation and propulsion system for a vehicle adapted to travel over a roadbed. If necessary, the present invention can be presented as to specifically exclude a magnetic levitation and propulsion system for a vehicle adapted to travel over a roadbed.

Coffey claims a guideway affixed to a support structure coupled to a roadbed. The present invention does not claim a guideway affixed to a support structure coupled to a roadbed. In the present invention, the inner walls of the glass tube keep the elevated object from moving outside of the direct vertical influence of the elevating electromagnet.

Coffey claims a repelling device and a repelled vehicle parallel to each other to generate a repulsive force between the guideway and the magnetic devices. In the present invention, the repelled object is positioned above the repelling object surface. In the present invention, the repelled object is position vertically at an approximate ninety degree angle relative to the surface of the repelling surface.

Coffey claims a plurality of propulsion windings affixed to a support structure connected to a power source and used to generate a vehicle repulsive force to propel a vehicle along a roadbed support structure. The present invention does not claim a plurality of propulsion windings affixed to a support structure connected to a power source and used to generate a vehicle repulsive force to propel a vehicle along a roadbed support structure. The phrase “ . . . to propel a vehicle along a road support structure . . . ” suggests a horizontal type movement of the vehicle. The propelling, repelling motion of the repelled object in the present object is vertical.

Coffey claims a guideway that is a pair of conductive sheets. In the present invention, there is no guideway that is a pair of conductive sheets.

Coffey describes a device which is used for “high speed transportation at ground level”. In the present invention, the device is used for transportation as in flying. The transportation described in the present invention is not described as high speed.

Coffey describes a vehicle that may be advanced over a guideway by propeller, jet, rocket, or other suitable propulsion means. In the present invention, the object is vertically transported as opposed to horizontal transport as described by Coffey. The present invention does not describe the use of a propeller, jet, rocket, or other suitable propulsion means.

Coffey describes “When vehicle 10 (not shown) is in motion, a repulsive force is created between the magnet 16 and guideway 18 by the interaction of the magnet and eddy currents induced in the guideway 18 by the time varying magnetic field of the passing magnet.” In the present invention, the motion of the elevated object does not create a repulsive force between the repelled object and the repelling electromagnet. In the present invention, the repelling electromagnet repels the object and causes the object to have vertical motion.

Coffey describes a vehicle positioned between the repulsion generating source and the repelling source. In the present invention, the elevated object is not positioned between the repulsion generating source and the repelling source. In the present invention, the object is positioned above the repelling source and does not include a repulsion generating source separate from the repelling source.

Coffey describes the magnet 16 as being “confined” within the guideway structure by LSM 20. Such confinement restricts the vertical movement of the vehicle described by Coffey. In the present invention, there is no confinement that restricts the vertical movement of the elevated object.

The difference between the electromagnet of an electromagnetic object in the present invention and the elevated electromagnet described by Coffey is described above.

The first statement in the Lovell patent is “This invention relates to an electromagnet for attracting non-magnetic conducting bodies as well as magnetic bodies”. Lovell also states in the first section of the patent “A further object resides in the fixing one closed conductor firmly to a structure of the field producing means to provide an electromagnet which will attract and hold a closed conductor even though it is non-magnetic and at some distance from the field producing means”. The present invention does not claim or describe a magnetic or electromagnetic attractive means for transporting, elevating, or moving objects. Lovell disclosed that electromagnets are well known to be used to be manipulated by magnetic and electromagnetic attraction. The present invention discloses electromagnets used to manipulate, and be manipulated by electromagnetic repulsion only. Lovell claims “an electromagnet, a closed conductor, an armature of non-magnetic conducting material adjacent thereto, . . . the armature being of such size and shape and so positioned as to be attracted to the closed conductor by electromagnetic flux forces”. The present invention claims a means to elevate and manipulate objects using repulsive electromagnetic forces. Lovell claims “ . . . said armature being so dimensioned with respect to the resultant field as to be held to the magnet by attracting electromagnet forces”. Lovell claims “ . . . an armature of non-magnetic conducting material adhering to said secondary by attracting electromagnetic forces arising from current circulated within the armature by induction”. Lovell claims “ . . . an armature of non-magnetic conducting material disposed in the resultant field, sail armature being so dimensioned and so positioned in the resultant field that the armature is attracted axially toward the electromagnet”. The present invention does not claim an armature of non-magnetic conducting material. The present does not claim any degree of attractive forces for the elevation and manipulation of electromagnetic objects. Lovell claims “An alternating current electromagnet comprising inducing means, attracting means fixed in position relative to the inducing means, and a member of non-magnetic conducting material held to the attracting means by axially attracting and laterally centering forces caused by interaction of fluxes of alternating currents flowing in the attracting means and of currents circulated with said member by induction. The present invention does not claim any component or object being held to an attracting means. Throughout the description, Lovell refers to the ‘attractor’ and to the ‘attracted mass’ as components of the invention. The present invention does not claim or describe an ‘attractor’ or an ‘attracted mass’ as components of the invention.

The NASA magnetic levitation system is a track. The NASA system is a (horizontal) “running start” to break free from the Earth's gravity. The present invention does not require or include a running start (in general) or a horizontal running start. In the present invention, the elevated object is immediately, increasingly, and continuously elevated against the Earth's gravity. The Maglev uses magnetic fields to levitate and accelerate a vehicle along a track (horizontally relative to the track). The present invention does not use magnetic fields to levitate and accelerate a vehicle along a track (horizontally relative to the track). The present invention immediately repels an object vertically away from the Earth's surface and towards orbit. The Maglev includes rocket engines for launch into orbit. The present invention does not include rocket engines for launch into orbit. The vehicle transport described by NASA is horizontal while the vehicle is on the track. The Maglev is positioned on the ground. The present invention can be positioned at places other than the ground and can still vertically repel and elevate an object. The Maglev system is described as “A 10-pound carrier with permanent magnets on its sides swiftly glides by copper coils, producing a levitation force”. The movement of the carrier with the permanent magnets on its sides produces the levitation force. In the present invention, the levitation is not caused by the movement of permanent magnets or by the movement of the object. The Maglev system uses magnetic fields to pull the vehicle upward as in levitating as opposed to the present invention which uses magnetic fields to push the object up as in levitating. The Maglev system uses magnetic fields “to lift a vehicle a few inches above the track” as opposed to the present invention which pushes the object to a wide range of heights much higher than a few inches above the repelling, levitating electromagnet. The latter may be viewed as in flying as opposed to the Maglev system which does not levitate the vehicle as in flying while the vehicle is associated with the track. The Maglev system describes the vehicle reaching the end of the track and then taking off like and airplane and then switching to more conventional rocket engines to continue to orbit. The present invention describes the elevated object as being immediately repelled and elevated towards the sky and towards space without the use of conventional rocket engines to continue to orbit. The vehicle transport described in the Maglev is horizontal and is along a track. The object transport in the present invention is vertical and does not involve a horizontal track. The Maglev system is also described as producing thrust in a straight line horizontally along a track. The present invention produces a vertical repelling force pushing the object upwards. In addition, the present invention produces a vertical repelling force pushing the object upwards and continuously and increasingly upwards over time unlike the Maglev system. The Eastern Illinois website describes “ . . . magnets will repel each other, or perhaps, repel each other until one spins around and then jumps back to the other”. The present invention describes a device that prevents the repelled magnet from spinning around and then jumping back to the other. Unlike the present invention, previous inventions describe use of magnetic vehicle or object repulsion and elevation only for the purpose of facilitating horizontal vehicle or object transport. The purpose of the present invention is magnetic object repulsion and elevation for vertical transport.

Regarding the NASA website in view of Easting Illinois, the present invention describes applications of electromagnets used to lift and repel objects that are not claimed or described by the referenced documents in the USPTO communication dated (i.e. mailed) Jul. 5, 2005. The referenced documents describe the use of electromagnets to lift and repel objects such that the lifting electromagnetic field is affecting or applied to the lifted and repelled object generally at a horizontal (180° degrees) or at a vertical (90° angles) both relative to the repelling electromagnetic source. In the present invention, the vertical lifting of the object is not done in order to contribute to the main direction of the lifted and propelled object motion or transport (which is a horizontal motion or transport while the electromagnetic lifting is occurring) as is done in the USPTO referenced documents. In the present invention, the vertical lifting of the object is a continuously increasing lifting and is a vertical object transport; even if there is no horizontal lifted object motion involved. In the present invention, the repelling electromagnetic field is also applied at different angles (i.e. different from the general 180° and 90° angles) to the lifted and propelled object. In the present invention, the horizontal motion of the electromagnetically lifted object may be affected or controlled by the interaction of an additional electromagnet positioned on the outside of the glass tube or by an additional electromagnet positioned on the lifted electromagnet during the increasing vertical object lifting. An additional difference between the present invention and the referenced documents include a continued and increasing lifting of the object as described in the present invention versus a maintained vertical elevation only to support horizontal transport while in the elevation process described in the referenced documents.

Regarding the Alien Baby and the Inductrack, reference is made to superconducting magnets lifting a vehicle to within a fraction of an inch of a rail guide primarily for horizontal vehicle transport. The application of magnetic fields to lift and manipulate objects in the present invention is for varying vertical distances much greater than the Inductrack and lifts the objects in a continuous and increasingly higher manner. Unlike the present invention, the Inductrack uses magnet arrays attached under a vehicle and a track guideway for horizontal vehicle transport. In the Inductrack system, the vehicle must reach a certain horizontal speed on the track in order for magnetic repulsion elevation to be induced. In the present invention, object elevation is induced immediately, in a vertical direction, without required horizontal motion, and in a continuous and continuously increasing manner. In each of the levitation techniques referenced in the Alien Baby, including electrodynamic, electromagnetic, and inductrack, the small degree of levitation height relative to the horizontal distanced traveled is very small. In the present invention, the height of elevation height relative to the horizontal is much greater than that of the Alien Baby Inductrack and the referenced levitation techniques.

Baker et al., claim “A method of setting to predetermined control levels individual control devices . . . ”. The present invention does not claim or describe a method of setting to predetermined control levels nor does the present invention claim or describe individual control devices. Baker et al. claim “ . . . a pivoted movable beam element whose movement is utilized in achieving the control function of the device . . . ”. The present invention does not claim or describe a pivoted movable beam element nor does the present invention claim or describe a pivoted movable beam element whose movement is utilized in achieving a control function of the device. Baker et al. claim “Control apparatus comprising a pneumatic force balance device . . . ”. The present invention does not claim or describe a pneumatic force balance device. Baker et al. also claim “ . . . a level of magnetism required to exert a wanted force on said beam to achieve a specified output from said device when said beam is balanced by a pneumatic force.” The present invention claims varying levels of electromagnetism required to elevate, and continuously elevate, and manipulate an object as in vertical object transport. Baker et al. describe “The permanent type magnet having windings is disposed adjacent to a balance beam which is movable in response to changes in the strength of the permanent magnetic having windings. The present invention does not describe a permanent type magnet having windings that is disposed adjacent to a balance beam which is movable in response to changes in the strength of the permanent magnetic having windings. The present invention describes an electromagnet positioned to elevate and manipulate an object. The experiment described in the present invention includes a glass tube used to reduce elevated object flipping and keeps the elevated object above the elevating electromagnet. Baker et al. describe “a principal object of this invention is to provide an improved method and apparatus for activating process control or other elements”. The present invention does not describe a method and apparatus for activating process control or other elements. Baker et al. describe “FIG. 1 shows, in diagrammatical form, an assembly which converts a magnetic force to pneumatic output . . . ”.

The present invention does not describe an assembly which converts a magnetic force to pneumatic output.

Metz, et al., claim “A lifting electromagnet, comprising a plurality of cores defining poles arranged to attract and support at least predominantly ferromagnetic objects . . . ”. The present invention claims an electromagnet positioned to elevate objects using electromagnetic repulsion. Metz et al. also claim a sensor, which is disposed between two poles, used to position the lifted and transported object. The present invention does not claim a sensor used to position the elevated object. Metz et al. describe a single or composite lifting electromagnet with several cores whose poles can attract round, elongated or otherwise configured ferromagnetic objects. The present invention describes a lifting electromagnet whose pole elevates objects through electromagnetic repulsion. Metz et al. describes sensors that generate signals that lead to the facilitation of automatic guidance of the electromagnet. The guidance of the elevated object in the present invention includes the light-weight ring attached to the bottom of the elevated object and the exterior width of the elevated object and its proximity to the inside walls of the glass tube. Unlike the present invention, Metz et al. also describe the position to which the object is to be lifted and transported to as the treating station of a machine tool.

Wipf claims “an improved magnetic suspension system for a moving vehicle . . . ”. The present invention does not claim a magnetic suspension system for a moving vehicle. The present invention does not claim an improved magnetic suspension system for a moving vehicle. The present invention claims an electromagnetic vertical object transport system. The present invention also describes an electromagnetic continuous vertical object transport system. Wipf claims “ . . . magnetic means coupled to the moving vehicle . . . ”.

The present invention does not claim magnetic means coupled to a moving vehicle or object. In the present invention, the elevated and manipulated object is not coupled to the repelling, electromagnet causing the object transport. Wipf claims “ . . . magnet means defining a track for the moving vehicle . . . ”. The present invention does not claim magnet means defining a track for a moving object or vehicle. The vertical vehicle movement Claimed by Wipf is described as “ . . . lifted and maintained in a self-stabilizing equilibrium as said magnet means moves along said conductor means.” The primary mode of transport in the present invention claims and describes vertical transport in a continuously increasing manner as opposed to a “self-stabilizing equilibrium” manner. Wipf claims “ . . . said magnet means moves at a predetermined relative velocity v . . . ”. The present invention does not claim magnet means moving at a predetermined relative velocity. In the present invention the distance the object travels per time or per time squared may vary. Wipf claims “ . . . a longitudinally extending channel member generally enclosing said magnet means”. The present invention does not claim or describe a longitudinally extending channel member or such a member enclosing a magnet means. The present invention claims vertical object transport. The Figures in the Wipf patent depict horizontal vehicle transport as the primary mode of vehicle transport. The Figures in the present invention depict vertical object transport as the primary mode of transport. Wipf describes “ . . . a magnet that is propelled along a continuous and nonferromagnetic conductor”. Wipf also describes “The moving magnet induces eddy currents in the conductor that oppose any change in the magnetic field and results in a force of repulsion that levitates the moving magnet at a predetermined velocity v.” The present invention does not describe a magnet or object that is propelled along a continuous and nonferromagnetic conductor. The present invention describes an object that is repelled vertically and continuously vertically above and away from a repelling electromagnet. The present invention does not describe a moving magnet that induces eddy currents in a conductor that opposes any change in the magnetic field and results in a force of repulsion that levitates a moving magnet or object that is propelled along a continuous and nonferromagnetic conductor. In the present invention, the repulsion and vertical transport of the object is caused by the elevating electromagnet.

Dolgin claims “A system for levitation which depends upon the Meissner effect and for vibration damping of a cryogenic instrument inside a cold chamber . . . ”. The present invention does not claim a system for levitation which depends upon the Meissner effect and for vibration damping of a cryogenic instrument inside a cold chamber. The present invention claims a system for elevating and manipulating objects which depends upon the repulsive forces between the lower positioned electromagnet and the elevated object. Dolgin claims “ . . . superconductive material rigidly attached to or coated on said cryogenic instrument inside said cold chamber . . . ”. The present invention does not claim superconductive material rigidly attached to or coated on said cryogenic instrument inside said cold chamber. Dolgin claims “ . . . a magnetic flux source outside said cold chamber, a vibration damping means attached to said magnet flux source outside of said of said cold chamber . . . ”. The present invention does not claim a magnetic flux source outside said cold chamber, a vibration damping means attached to said magnet flux source outside of said of said cold chamber. Dolgin Claims “ . . . said cryogenic instrument is levitated by force generated by Meissner-effect repulsion, and vibrational energy of said superconductive material rigidly attached to or coated on said cryogenic instrument is transferred to said magnetic flux source outside said cold chamber and there dampened by said vibration damping means.” The present invention does not claim a cryogenic instrument levitated by force generated by Meissner-effect repulsion, and vibrational energy of said superconductive material rigidly attached to or coated on said cryogenic instrument transferred to said magnetic flux source outside said cold chamber and there dampened by said vibration damping means. Dolgin claims “ . . . vibrational energy of said superconductive material is transformed into electrical current . . . ”. The present invention does not claim vibrational energy of said superconductive material is transformed into electrical current. Dolgin claims “ . . . electrical current in said pick-up coil which is in turn transformed into heat in said series connected resistor to dampen vibration of said superconductive material and thereby dampen vibration of said cryogenic instrument.” The present invention does not claim electrical current in a pick-up coil which is in turn transformed into heat in a series connected resistor to dampen vibration of a superconductive material and thereby dampen vibration of a cryogenic instrument. Dolgin describes “This invention relates to the use of superconductive material and magnets for the Meissner effect to provide both load bearing support and vibration damping of cryogenic instruments in spacecraft or aircraft without having any physical contact with the cryogenic instrument.” The present invention does not describe the use of superconductive material and magnets for the Meissner effect to provide both load bearing support and vibration damping of cryogenic instruments. The present invention does not describe object elevation, manipulation, or transport without having any physical contact with the cryogenic instrument. Dolgin describes “ . . . An object of this invention is to provide a load-bearing support without having any physical contact with the cryogenic instrument, i.e. levitation and vibration damping for precision cryogenic instruments aboard aircraft or spacecraft . . . ”. The present invention does not describe an object of the invention being to provide a load-bearing support without having any physical contact with the cryogenic instrument, i.e. levitation and vibration damping for precision cryogenic instruments aboard aircraft or spacecraft.

Dolgin describes “ . . . a pick-up coil 14 which senses any motion of the flux source 13.” Considering FIG. 1, the immediately preceding sentence indicates the vertical, especially vertical and upward motion of the flux source 13 towards the superconductor material position (with a ‘stationary’ pick-up coil 14) is therefore attracted in an upward motion towards the superconductor material 10. The present describes vertical repulsion object movement away from the electromagnet.

The basic principles of magnetism and prior art do not address the continuously increasingly vertical elevation of objects using electromagnetic repulsion as a mode of vertical transport as in flying. The basic principles of magnetism and prior art do not address vertical transport, during the elevation process, as the primary mode of transport as opposed to electromagnetic repulsive object elevation contributing to horizontal object transport and with horizontal transport as the primary mode of transport. Illustrations associated with the present invention address these considerations and are not merely addressing the basic principles of magnetism. The basic principles of magnetism and the prior art do not address the use of very large or powerful electromagnets to repel and continuously and increasingly vertically elevate an object as in flying.

The basic principles of magnetism and elevation and the prior art do not address materials through which two different electromagnets may repel and only during the repulsion process, each other for the purpose of vertically elevating one of the electromagnets or an object in a continuously vertical and increasingly vertical manner as in flying, and only during the repulsion process, or such that the primary mode of transport is vertical transport as in flying only during the repulsion process.

The distance of vertical elevation in the present invention is much greater than that of the elevated object or vehicle claimed or described in the prior art and the flying type distances in the present invention are not a subset of the prior art. If dₚᵣₑₛₑₙₜ is the object elevation distance in the present invention, dₚᵣᵢₒᵣ is the object or vehicle elevation distance in the prior art, and drying is the distance at which the object is flown, then we may write dₚᵣₑₛₑₙₜ>>dₚᵣᵢₒᵣ and d_{flying} is not a subset of dₚᵣᵢₒᵣ.

The patents described above do not address the use of electromagnetic fields only to directly elevate and manipulate objects (i.e. without converting laser or electromagnetic energy into fueled propulsive energy) similarly as objects are elevated and manipulated in rotary-wing and non-WinG-wing flight. Nor do the patents described above address the use of electromagnetic (only) to transport larger objects (i.e. without converting laser or electromagnetic energy into fueled propulsive energy) similar to automotive, machinery, or other modes of people or larger object transport (i.e. without converting laser or electromagnetic energy into fueled propulsive energy). Note that the present WinG-wing and non-WinG-wing modes of flight generally require the use of flammable, combustible, or other fuels.

To overcome these shortcomings, the present invention provides a mode of elevating and manipulating objects similar to wing and non-wing flight using electromagnetic fields. The present invention also provides a mode of transporting larger objects similarly to automotive, machinery, or other modes of people or larger object transport.

### BRIEF SUMMARY OF INVENTION

It is the object of the invention to a) provide a mode by which objects may be elevated and manipulated by electromagnetic fields, b) provide a mode of flight comparable to WinG-wing and non-WinG-wing flight, and c) provide a mode of transport comparable to people and larger object transport such as automotive and machinery modes of transport.

### BRIEF DESCRIPTION OF SEVERAL VIEWS OF THE DRAWINGS

FIG. 1 shows the field producing source with objects in three example elevated positions such that the objects are able to be manipulated by the electromagnetic field source, by the object itself, or by other sources in upward, downward, left or right directions, or angular or circular directions along X, Y, or Z axes.

FIG. 2 shows two electromagnets A and B that have the same polarities facing each other.

FIG. 3 shows two electromagnets including Electromagnet A, which is very large and stationary, and electromagnet B facing each other as in FIG. 2.

FIG. 4 shows a single, stationary field producing source or device (i.e. electromagnet A) exerting an electromagnetic field at angles in the direction of the electromagnetic field of objects 1 and 2 (i.e. electromagnet B and electromagnetic C, respectively).

FIGS. 5 and 6 show stationary electromagnet A repelling and maintaining electromagnet B in position 1. A second stationary Electromagnet C may exert an electromagnetic field in the direction of the electromagnetic field of electromagnet B as electromagnet A also exerts a electromagnetic field towards electromagnet B. Electromagnet B may also exert an electromagnetic field in the direction on one or more of the stationary electromagnets.

FIG. 7 shows a stationary field producing source or device (Electromagnet A) positioned below the earth's or other surface exerting an electromagnetic field towards object 1 (Electromagnet B) and hence repelling object 1.

FIG. 8 shows a very large or powerful stationary field producing source or device (Electromagnet A) exerting an electromagnetic towards the magnetic field exerted by object 1 (the space shuttle with and without two solid rocket boosters.

FIG. 9 shows an aircraft (object 1 and Electromagnet E) going down a runway and taking off as five stationary electromagnets exert electromagnetic fields towards object 1 (i.e. Electromagnet E).

FIGS. 10 and 11 show electromagnets M1 and M2 with same polarities facing each other with the within a glass tube. With both electromagnets positioned in a glass tube, distances of d, d/2, d/4, and d/8 are shown in D, C, B, and A. The electromagnet repulsive forces between M1 and M2 cause varying distances between the two electromagnets. FIG. 11 also shows the electromagnetic power of M1 for the varying distances d for D, C, B, and A as P_{M1}=5 J/s, P_{M1}=0.5 J/s, P_{M1}=0.05 J/s, and P_{M1}=0.005 J/s, respectively.

FIG. 12 shows electromagnets M1 and M2 with same polarities facing each other with the within a glass tube. The glass tube has a round bottom or is able to rock or tilt. With both electromagnets positioned in a glass tube, distances of d, d/2, d/4, and d/8 are shown in D, C, B, and A. The electromagnet repulsive forces between M1 and M2 cause varying distances between the two electromagnets. FIG. 12 also shows a second glass tube attached to a wall or stable position allowing a third electromagnet M3 (with the same polarity as elevated electromagnet M2) facing the polarity of M2 moving from right to left towards elevated M2. As electromagnet M3 gets closer to elevated electromagnet M2, M2 is repelled away from M3 and hence the glass tube containing M2 moves into the second position.

FIG. 13 shows a device or object (3) to be elevated inside a glass enclosure (1) including the elevating electromagnet below the device or object (2), component (5) to stabilize the elevated device or object, and a light-weight, sturdy rigid material (4) extending downward from the center of the triangular shaped component.

FIG. 14 shows the elevated device or object (3) in position 1 and position 2. The elevated device or object is elevated by a powerful electromagnet base (2) and electromagnetically repelled and forced to move horizontally from position 1 to position 2 by repelling electromagnet positioned on the walls of the enclosure. Each of the repelling electromagnets have the same polarities as the elevated device or object. In all drawings including FIG. 14, a power source is included as necessary.

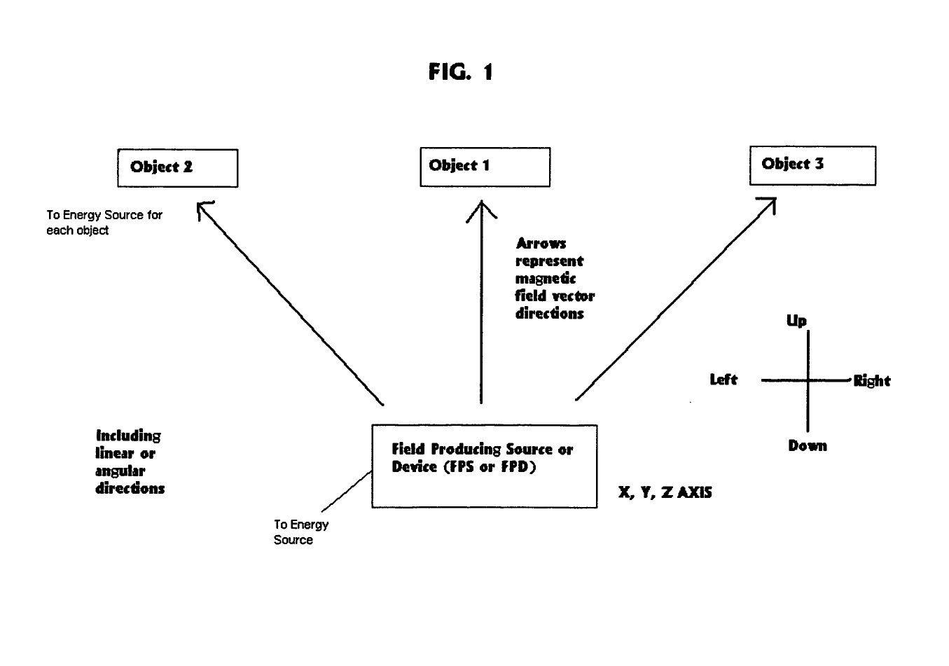

Each of the objects shown in FIGS. 1 to 14 are designed and equipped such that each may elevate and manipulate itself. Energy sources are provided for the electromagnets shown in FIGS. 1 to 14.

### DETAILED DESCRIPTION OF THE INVENTION

### (References are to Illustrations)

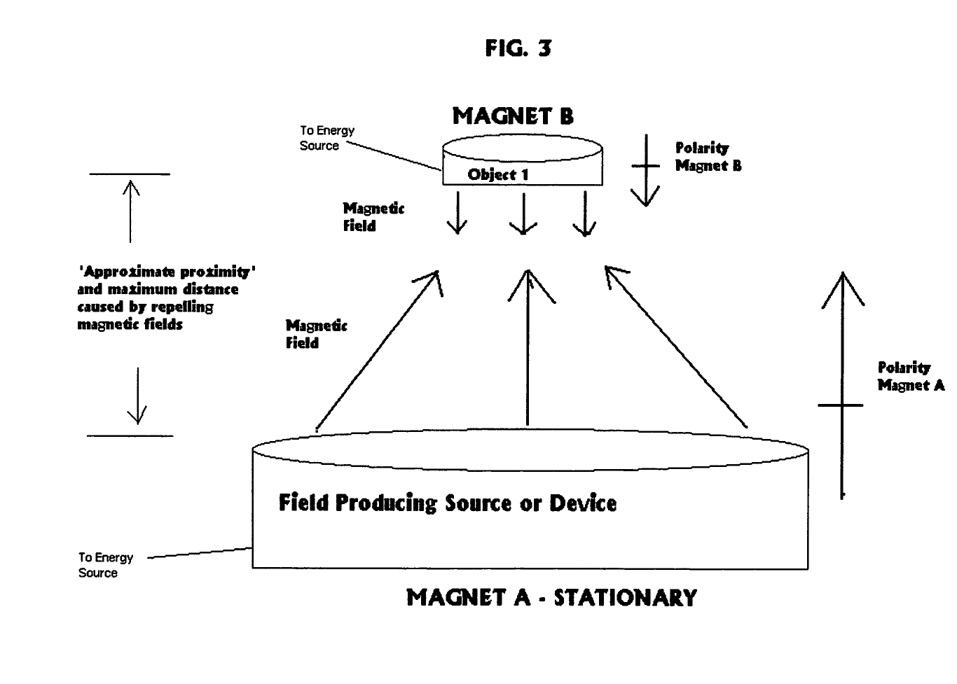

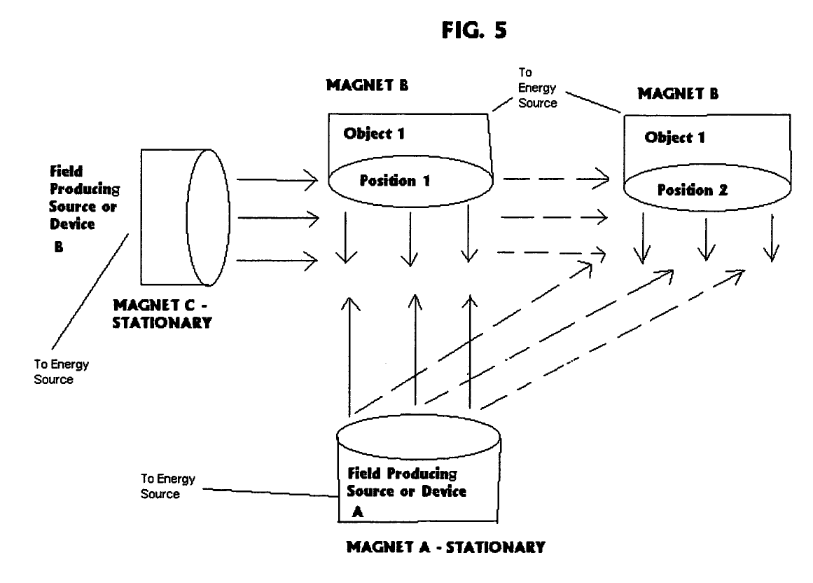

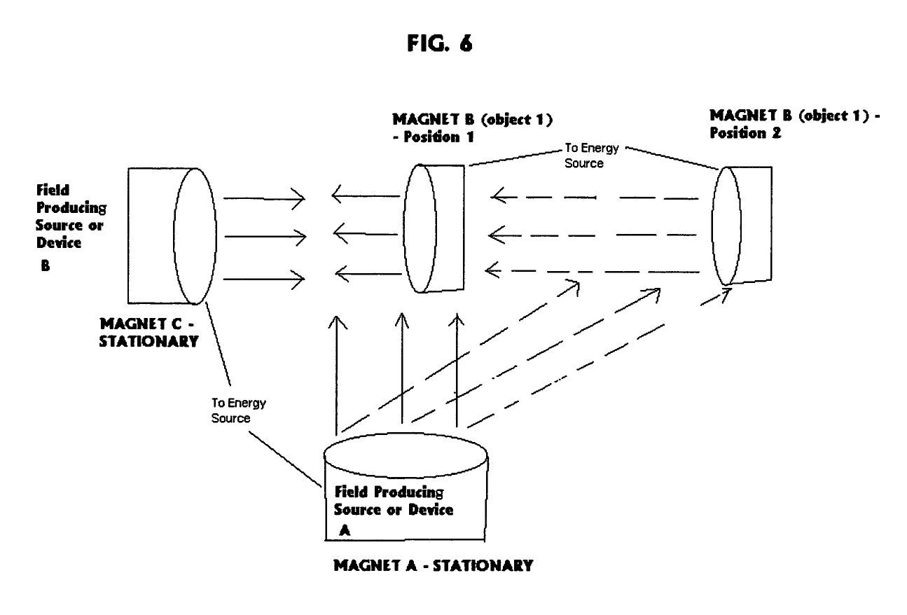

The present invention consists of a mode of elevating and manipulating objects using fields only that a) is equipped with at least one electromagnetic field producing source or device positioned as to exert or potentially exert the produced field onto or about an object, boundary, or surface of an object such that the object(s) is elevated (as in two flat-faced magnets of the same polarity facing each other, one above the other, for example) and manipulated by the field producing source, the elevated or manipulated object, or by other means (see FIGS. 1 through 14), b) is made, drawn, or designed such that the strength or degree of the field from the field producing source(s) or devices may be manipulated by the field source(s) or device(s), the elevated and manipulated object(s), or other entity, and c) equipped such that the field producing source(s) and the elevated and manipulated object(s) operate in a desired manner. As shown in FIG. 3, which shows and example using a magnetic or electromagnetic field producing device, a very large or powerful magnetic or electromagnetic field producing device is positioned in, on or about a location. The field producing device or source is made such that the strength, energy, or direction of the field, especially as the field affects the elevated and manipulated object, may be controlled. FIG. 1 through 14 also show the faces of smaller objects with the same or similar polarities as the field source(s) facing the field sources or devices. FIG. 1 through 14 are examples of the objects being repelled or pushed upward or about by the produced field. The strength or energy of the produced field may be initially zero or very small as in prior to pushing or as in initializing the push of the object in an upward direction, for example. The strength of energy of the field producing device or source may be increased or varied as to elevate and manipulate the object(s). Multiple field producing devices or sources (like the one shown in FIGS. 5 and 6) may be used as one effort to elevate and manipulate the object(s). The present invention consists of the elevated and manipulated object(s), the field producing device(s) or source(s), or other mechanisms that are made, drawn, or designed as to allow the object(s) to be manipulated or operated as desired.

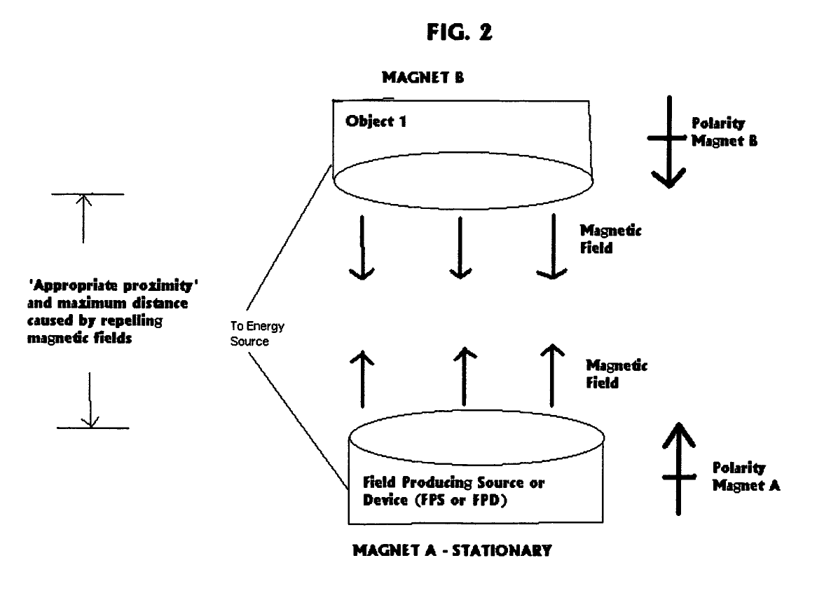

Electromagnet A and Electromagnet B in FIG. 2 are identical. The faces of the electromagnets with the same electromagnetic field direction or polarity are directed towards each other. All objects and field producing sources may receive or emit magnetic or electromagnetic field energy. The two electromagnets, therefore, repel each other when the two electromagnets are in approximate proximity (i.e. at a distance that allows the electromagnetic fields to interact). Considering a) the fact that the electromagnetic field strength of the electromagnet may be controlled, b) the fact that Electromagnet A is in a stable position (or platform), c) Electromagnet B is directly over Electromagnet A at a maximum degree of repulsion and hence at a maximum distance Electromagnet, and d) Electromagnet B is held in position above Electromagnet A only by the repelling electromagnetic fields produced by each electromagnet, decreasing the electromagnetic field strength of Electromagnetic A would result in less repulsion of Electromagnet B and hence a decrease in the distance between Electromagnets A and B. The electromagnetic field strength of Electromagnet A may be reduced until Electromagnet B became very close to Electromagnet A. At this point, the field strength of Electromagnet A may be increased such that Electromagnet B is repelled upward and away from Electromagnet A. The fields produced in the FIG. 2 may be magnetic or electromagnetic field(s) and the objects must be ‘repelable’ by the electromagnetic field-producing source (FPS). The position of object 1 may be maintained and sustained by an appropriate or constant electromagnetic field of the FPS. The position of object 1 may be varied by varying the field strength of the FPS or object 1. Object 1 may therefore be elevated and manipulated by the FPS. Object 1 may be considered as or may be appropriately positioned about an automotive unit(s), machinery, persons, or other large objects. Hence, as object 1 is elevated, maintained, or manipulated, similarly may an automobile, machinery, persons, or other large objects be elevated, maintained, or manipulated.

Considering FIG. 3, the maximum distance between objects 1 and the FPS is greater in FIG. 3 than in FIG. 2 because of the increased electromagnet field strength of the FPS in FIG. 3 as compared to that of the FPS in FIG. 2. The distance between objects 1 and the FPS in FIGS. 2 and 3 may be decreased by decreasing the electromagnetic field strength of the FPS or object 1.

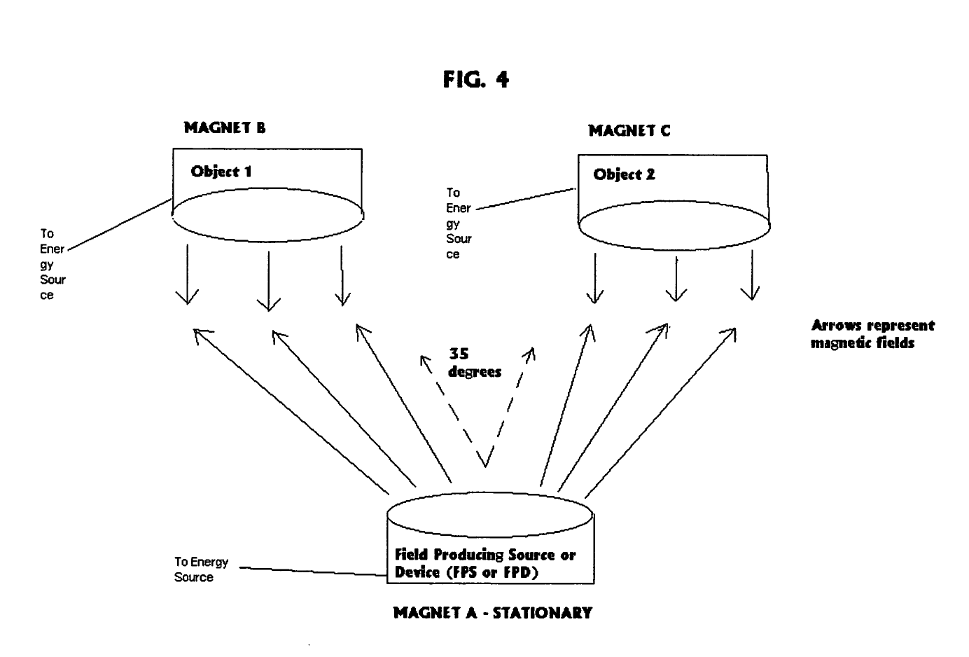

Considering FIG. 4, the field-producing source may exert an electromagnetic field on objects 1 and 2 at any angle, direction, or orientation. As in the prior Figures, the position of the objects may be sustained or varied by varying the field strength or direction of the field producing source or device. As shown in FIG. 4, the present invention may be composed of multiple objects or field producing sources or devices.

As shown in FIG. 5 and considering a) the prior illustrations and descriptions and b) the facts that Electromagnets A and C are in stationary positions, a second field producing source or device (Electromagnet C) may exert an electromagnetic field onto the electromagnetic field produced by object 1 (Electromagnet B) simultaneously as field producing source or device 1 (Electromagnet A) exerts an electromagnetic field on the electromagnetic field produced by object 1. The result of both field-producing sources exerting electromagnetic fields onto the electromagnetic field of object 1 (as shown in FIG. 5) is the manipulation of object 1 from position 1 to position 2. Likewise, in the appropriate environment (high above ground, for example), the manipulation of object 1 by both field producing sources or devices may result in object 1 being viewed as flying (similar to wing and non-wing flight) from position 1 to position 2.

As shown in FIG. 6 and considering the fact that Electromagnets A and C are stationary and considering the prior illustrations and descriptions, object 1 may be initially sustained in position 1 by the electromagnetic fields exerted by the stationary field producing sources or devices and by object 1. Increasing the field strength of object 1 in the direction of the electromagnet field of Electromagnet C results in the increased repelling of object 1 by Electromagnet C (or vice versa) and hence the manipulation of object 1 from position 1 to position 2. Object 1 may control its own elevation and manipulation.

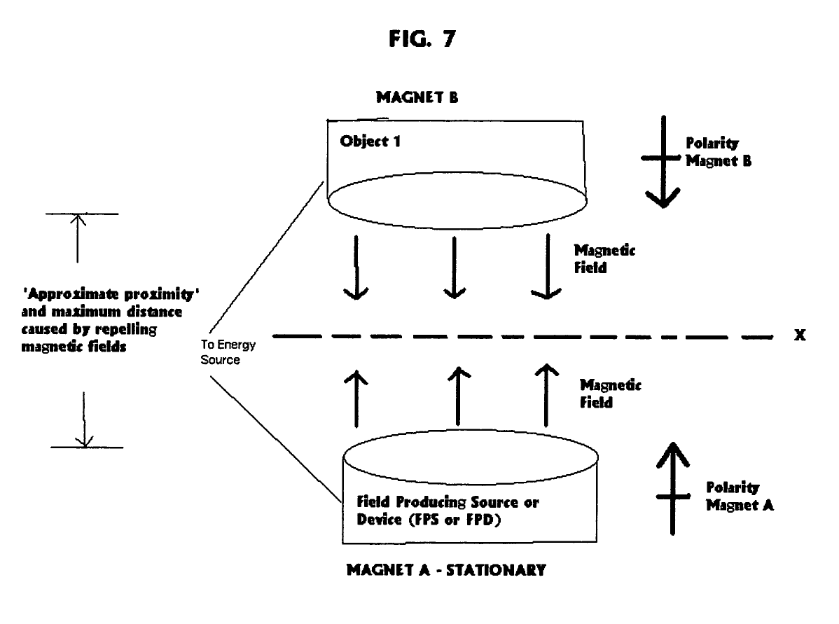

Considering FIG. 7, either Electromagnet, including the field producing source(s) or device(s) or any object or Electromagnet, may be located below or within the earth's surface, which is represented by ‘x’, may exert an electromagnet field onto or in the direction of the electromagnetic fields of other Electromagnet(s).

Considering space flight, the present invention is equipped with a large with a large or strong magnet or electromagnet field-producing upon or above which a space shuttle or other craft may be placed. The space shuttle may be equipped with elevatable materials (such as electromagnets with the same or similar polarities as the field producing source or device on the bottom of the shuttle facing the field source) distributed about the craft. The magnetic or electromagnetic field of the shuttle is in the direction towards (or may be affected by) the positioned large or strong magnet(s) or electromagnetic(s). The shuttle may be elevated and manipulated by the positioned, large or strong magnetic or electromagnetic field, and the field source(s) or device(s) acting on the space shuttle may contribute to the initial, upward, or other push of the craft. Note that in the case of elevating the space shuttle, the elevation may take place in conjunction with present or fueled modes of space shuttle launching with or without the large solid boosters.

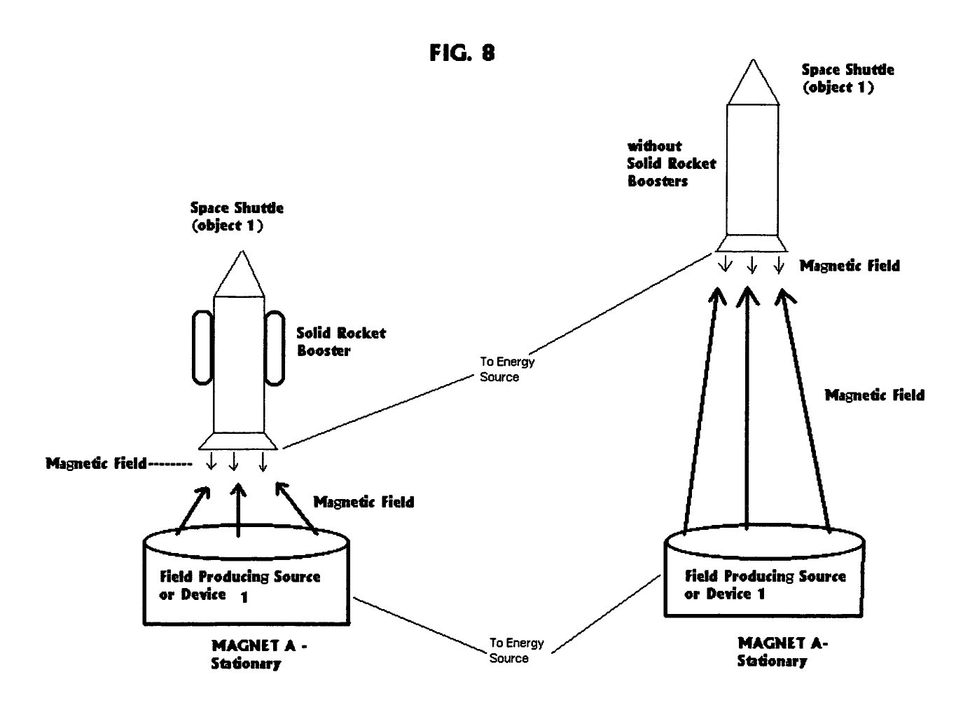

Considering FIG. 8 and a) the prior illustrations and descriptions and b) the space shuttle may be equipped with field producing sources or devices, the space shuttle (object 1) may be elevated and manipulated by the stationary field producing source or device Electromagnet A. Increasing the strength of the field producing source or device and removing (or reducing the size of) the solid rocket boosters from the space shuttle (object 1) results in an increase in the repulsion between the field producing source or device and the space shuttle (object 1) and hence results in and increase in the distance between the field producing source or device (Electromagnet A) and the space shuttle (object 1). The space shuttle may therefore be elevated by the field producing source or device. The space shuttle may also be elevated and manipulated as shown in FIGS. 5, 6, and 7.

Considering flight and considering the above descriptions, the present invention is equipped with multiple or very large or strong magnet(s) or electromagnetic(s) (or other field producing sources or devices) over which a single object (such as a flying craft) may be manipulated, elevated, or maintained in an elevated position in vertical, horizontal, angular, and other directions. The objects in FIG. 1 through 8 may be considered the flying craft(s). Considering aircraft flight take-off, aircraft may be elevated vertically only or may be elevated as the craft is taking-off down a runway. In this example, magnets or electromagnets (or other field producing source or device) are positioned along the runway (or elsewhere) exerting the magnetic or electromagnet (or other) field in the direction of the aircraft which is equipped with opposing or elevatable magnetic or electromagnetic (or other) field producing devices or sources (of same or similar polarity as the large field producing source or device) about the craft (same as the runway positioned magnetic or electromagnetic or other field source or device). The field producing source or device positioned on the runway may exert its field strength or energy as to contribute to the vertical or upward or other movement of the aircraft.

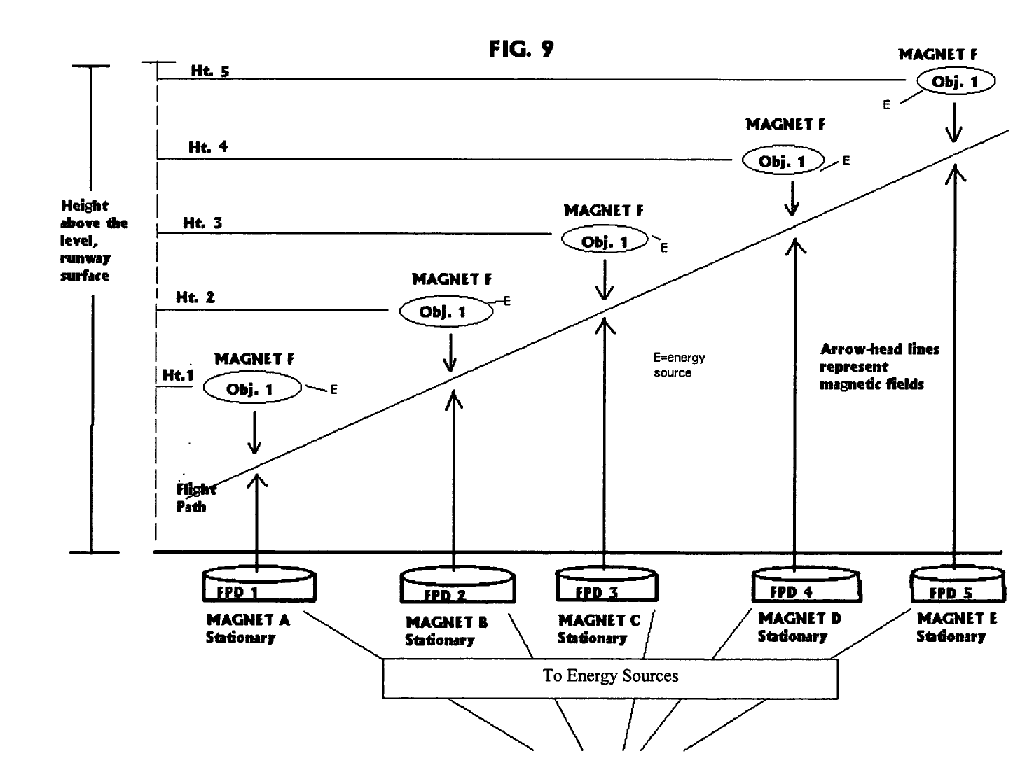

Considering FIG. 9 and the descriptions and illustrations associated with FIGS. 1 through 8, field producing sources or devices (FPD) or stationary Electromagnets (Electromagnets A through E) may be positioned appropriately along or below the runway or level surface may a magnet field in the direction of Electromagnet F (i.e. object 1 or the aircraft) as to repel the aircraft as a result of the electromagnetic fields (i.e. from the FPDs and from the aircraft) repulsion. As the aircraft takes off along the runway, increasing the electromagnetic strength of the stationary Electromagnets (i.e. regarding electromagnet strength, FPD1<FPD2<FPD3<FPD4<FPD5) results in an increase in the height of the aircraft above the runway surface (i.e. aircraft Ht.1<Ht.2<Ht.3<Ht.4<Ht.5). The aircraft may be elevated and manipulated as described and illustrated in FIGS. 1 through 8.

Considering the elevation and manipulation of objects in general, the present invention is equipped with at least one field producing source or device, such as a field producing electromagnet, and at least one object, such as a smaller electromagnet of same or similar polarity, such that the smaller object is positioned (in a stable manner) directly above the large or strong field producing source or device. The field producing source or device contributes to the upward or vertical or other movement, elevation, and manipulation of the object.

Considering a) the elevation and manipulation of persons (or objects) in recreational and other activities, b) materials (or objects) used in construction activities, c) vehicles (objects) used in human transportation activities, d) toys or toy components unlike Hwang (D397,376), and e) other conventional modes of object elevation and manipulation such as cargo transportation, the present invention is equipped with at least one larger or stronger field producing source or device and at least one object which may be elevated or manipulated as described above.

Each of the objects shown in FIGS. 1 to 9 are designed and equipped such that each may elevate and manipulate itself. Energy sources are provided for the electromagnets shown in FIGS. 1 to 9 and may be within or about the magnets or objects.

Force, F, is defined as the mass, m, of an object times the acceleration, a, of the object, or F=ma. Work, W, is defined as the force acting on an object times the distance, d, over which the force acts on the object times the cosine of the angle, theta (θ), between the force and the displacement or W=F*d*cos θ. Joule, J, is a unit of work and 1 J=1 N*m where N is Newtons having units of kg(m/s²)*m and kg is kilograms, m is meters, and s is seconds. The Work-Energy equation states that the net force acting on an object over a distance x is equal to the final kinetic energy minus the starting kinetic energy, or FₙₑₜΔx=½ mv²-½ mv₀² where m is mass, v is the velocity of the object, and v₀ is the initial velocity of the object.

Electromagnets exist that have magnetic fields as high as 60 T (Long-Pulse magnet) and 850 T (strongest Destructive Pulsed magnet) according to the NHMFL at Florida State University. As a note, the electric field strength, E, may be defined as E=Hx377 where H is the magnetic field strength and 377 is a constant measured in ohms. The NHMFL facility is powered by a 40 million watt power supply and includes a 1430 megawatt motor generator (equivalent to the power of over 400 railroad locomotives) and 64 MW power supplies and was initially used to power the 60 Telsa Long-Pulse magnet. They use a combination of high strength-high conductivity conductors and very high reinforcement materials to control the enormous force caused by the 50 T and 60 T fields produced in the coils.

The Si unit for magnetic fields is the telsa, T. One gauss is 10-4 T and the earth's magnetic field is approximately ½ a gauss (or approximately 3×10⁻⁵ T at the earth's surface). One T is equivalent to one (Newton-second)/Coulomb-meter (Cm), or 1 T=1 Ns/Cm.

Regarding circular magnetic fields distribution and intensity when current is passed through a conductor and a magnetic field forms in and around the conductor, the field strength outside the conductor is directly proportional to the current strength.

A Joule, J, is a unit of work, W, and 1 J=1 N*m where N is Newtons and m is meters. A Telsa, T, is a unit of magnetic fields and 1 T=N*s/Cm where N is Newtons, s is seconds, C is Coulombs, and m is meters. From the second sentence, we may define 1 N=TCm/s and hence from the first sentence 1 J=(1 TCm/s)*m. We may therefore define an amount of work using magnetic or electromagnetic field units. One Joule of Work by a vertically repelling electromagnet on an elevating object would require (1 TCm/s)*m. Considering the previously described equations in this paragraph and an additional definition for Work, W=F*d*cos t, and the substitution of F or force acting on an object of mass m repelled to a vertical distance of d, we may also define the number of Telsa required for a repelling electromagnet to perform a particular amount of work on an object for a distance d. These equations may be used to determine the amounts of work, force, and electromagnetic field required to elevate and sustain elevation of an object to a particular vertical distance, d, or height.

The mass of an object, m, is defined as the weight of the object divided by the acceleration due to gravity. Considering vertical elevation of an object as a result of magnetic repulsion, the force that must be overcome, and hence the force and work that must be applied must overcome the force of gravity acting on the mass of M2. The force, F, acting on an object, M2, may be defined as the mass of M2 multiplied by the acceleration. The amount of work, W, acting on M2 may be defined as the force acting on M2 times the distance, d, for which the force is applied. The amount of power, P, or electromagnetic field strength or pressure, PE, required to vertically repel a second magnet, M2, to a distance d may be defined as the amount of work over the time for which the work is applied to vertically repel M2. Because the electromagnetic field is the source of force, F, and work, W, acting on the mass of M2, then an electromagnet providing an appropriate amount of electromagnetic field strength or pressure may elevate an object of mass m to a distance of d by overcoming the gravitational pull of the earth. An appropriate amount of energy may be provided to the electromagnet in order for it to provide an appropriate force and amount of work over time to maintain the object elevation. The amount of repulsive and elevating power required by the electromagnet to vertically elevate object M2 to the height of d may be described as the amount of power, P, is equivalent to the amount of work, W, including the force, F, acting on object M2 per the amount of time for which the object is being acted (by F, W) upon; Hence, we may write W=F×d and P=W/t.

An experiment used to determine values of vertical electromagnetic repulsive work on an object (the object may be a magnet or include a magnet) includes the placement of a four-inch diameter electromagnet in the bottom of a glass tube (a thick wall glass tube or other structure or mechanism) having a slightly greater than four inch diameter, allowing the object to move freely, positioned such that the electromagnet may repel a light-weight, four-inch diameter magnetic object vertically. The thickness of the outer edges of the lightweight object may be one inch for example. But the thickness of the outer edges of the lightweight object must be made such that relative to the distance of object outer edges from the glass tube inner walls, the thickness of the magnetic object edges provides object stability while the object is vertically elevated and the elevation is sustained. With the electromagnet initially off and the magnetic object positioned inside the glass tube above the electromagnet such that the object may be repelled, the electromagnet is turned on slowly. The magnetic object will be slowly elevated by, and above the bottom electromagnet field and the object elevation will be maintained at various or particular heights. This is depicted in FIGS. 1-3 and 5 and 6 as the Field Producing Source or Device or the electromagnet at the bottom of the glass tube vertically repels and elevates the magnetic Object 1. Varying the power or strength of the electromagnet field will vary the elevation height of the magnetic object above the bottom electromagnet. Parameters that may be measured using this experiment include the work, W, and Telsa, T, required to vertically repel and elevate objects of mass, m, to various heights, d. The elevated magnetic object may also have smaller diameters than the diameter of bottom electromagnet (two inches for example) if the magnetic object has an additional mass connected to, and hanging downward from the magnetic object as to contribute to the stability and flipping reduction of the magnetic object during elevation; i.e. appropriate center of mass. The additional mass may also have a light-weight ring attached to its lower end with a diameter similar and less than the diameter of the inner glass tube walls (three and seven eight inches, for example). If the glass tube has a rolling device such as wheels, then another electromagnet may be positioned at the level of the elevated magnetic object such that this additional electromagnet may repel and force the magnetic object to move horizontally. If the glass tube is able to rock, then the tube will rock or move away from the additional electromagnet. Hence, the magnetic object may be experimentally elevated and manipulated using electromagnetic fields in a stable manner considering the elevated and manipulated magnetic object. Note that the glass tube is only an example of a technique used to reduce the flipping of the magnet and hence stabilize the elevated electromagnet and to keep the elevated electromagnet over the electromagnet positioned at the bottom of the glass tube. The material, size, type, and design of the structure, equipment or part of the experiment that reduces the flipping of the electromagnet and increases the stability of the electromagnet, and keeps the elevated electromagnet above the bottom electromagnet may vary. The position and direction of the glass tube or the elevated object stabilizing structure or mechanism is represented in the present invention Figures by the arrows, including the outer arrows, depicted from and to the field producing sources including the bottom positioned elevating electromagnet. The properties and dimensions (including the diameter) of the electromagnet at the bottom of the glass tube, the elevated electromagnetic object, the electromagnet on the outside wall of the glass tube, and the smaller electromagnet attached to the elevated electromagnet may vary. Each of the electromagnets involved in all parts of all experiments may be powered by external or other power sources.

The experiment above can be repeated with two two-inch diameter open-bottom-ended glass tubes positioned at eighty degrees and one hundred degrees (i.e. relative to the surface of the electromagnet atop which the two glass tubes are positioned) atop a large ten inch diameter repelling and elevating electromagnet. This experiment depicts the elevation and manipulation of multiple objects, as well as the elevation and manipulation of objects at different angles, using electromagnetic fields as shown in FIG. 4.

The experiments above can be repeated with a round piece of paper having a four inch diameter (i.e. a diameter equal to that of the electromagnet positioned at the bottom of the glass tube) placed on top of the bottom electromagnet. This experiment depicts the elevation and manipulation of an object as the repelling electromagnetic fields pass through a material and then to the elevated object. Similar materials such as cloth, glass, porous materials, and other materials, through which the electromagnetic field of the electromagnet positioned at the bottom of the glass tube may also be placed on the surface of the bottom electromagnet or between the bottom electromagnet and the elevated electromagnetic object. Porous materials may also include thin asphalt and concrete materials. This experiment therefore depicts the use of electromagnetic fields to elevate and manipulate objects when the electromagnetic fields pass through materials such as different layers of the porous earth's surface as shown in FIG. 7.

An electromagnet (positioned at the bottom of the glass tube for example) is described as emitting an electromagnetic field when the repelling electromagnetic field from said electromagnet is interacting with and repelling another electromagnet (the elevated electromagnetic object for example). The electromagnet (the elevated electromagnetic object) that is repelled by said electromagnet is described as receiving an electromagnetic field from the elevating electromagnet. Variation in the power provided to each electromagnet determines the degree of variation in electromagnetic strength or power and hence the degree of electromagnetic field emitted or received by an electromagnet may be varied.

Criswell (1993) describes the use of lasers or electromagnet fields to energize the propellant trail of a rocket for combustion and Kare (1992) describes the use of focused (using focusing mirrors) laser or electromagnetic energy to break down air or other fluids creating plasma. This information addresses directing an electromagnet field in a specific direction and to a specific location and the control of an electromagnetic field to an object at a distance using electromagnetic energy laser. Lasers may also be used in the present invention to stabilize the elevated object in the present invention.

Electromagnets are available and strong enough to vertically repel and lift objects such as living persons and aircraft as well as scale and replica size persons, aircraft, spacecraft, and other objects as in flying. Electromagnets may also contribute to the lift off of the scale and replica size space shuttle, considering thrust and as in flying, to a limited but measurable degree. The invention may therefore contribute to thrust, as in flying, of the space shuttle into or towards space. Regarding the positioning of an electromagnet at heights to affect lifted and manipulated objects, the repelling electromagnet may be positioned on the earth's surface or on something that is positioned on the earth's surface or the repelling electromagnet may be positioned on an aircraft, spacecraft, or something in the air or in space.

The heights of object elevation associated with the present invention for the various applications may be determined using the equations and experiments described herein. The electromagnetic elevation heights associated with the present invention include vertical object transport as the primary mode of transport and heights other than those heights associated with primarily horizontal object transport supported by electromagnetic elevation. The electromagnetic elevation heights associated with the present invention are continuously increasing vertical elevation heights associated with vertical object transport as the primary mode of transport. The elevation heights associated with the present invention are not for a horizontal mode of object transport as the primary mode of transport.

Considering the experiment described above, the glass tube may be constructed such that a) the tube would lean or rock easily or b) the tube would be equipped with wheels or a roller on the bottom of the glass tube such that the tube would roll easily if appropriate forces were applied horizontally to the elevated object (i.e. in close proximity to the magnetic field of the elevated object), object 1 in position 1. While the magnetic object, or Object 1, is elevated by and above the electromagnet which is located at the bottom of the glass tube, a second hand-held electromagnet with the same polarity as the elevated object may be moved horizontally (at the same height as the elevated magnetic object) towards the elevated magnetic object, or Object 1. As the second hand-held magnet is moved close to the elevated magnetic object, the hand-held electromagnet will repel the elevated magnetic object away from the hand-held electromagnet. Hence, the glass tube will lean away from the hand-held electromagnet as the magnetic object is repelled away from the hand-held electromagnet or the glass tube will roll away in response to the same. Hence, the second hand-held electromagnet repels and manipulates the elevated magnetic object. The positioning and movement of the hand-held electromagnetic may also be done mechanically or enhanced using technology. This is depicted in FIG. 5 as the electromagnet at the bottom of the glass tube is represented by the Field Producing Source or Device A, the elevated magnetic object is represented by Object 1, and the second, hand-held electromagnet is represented by the Field Producing Source or Device B which is positioned level with the elevated magnetic object and repels the elevated magnetic object from position 1 to position 2.

Considering the experiment described above, the elevation of the magnetic object may be sustained in the glass tube by and above the electromagnet located at the bottom of the glass tube by providing an appropriate and constant repelling electromagnetic force from the electromagnet at the bottom of the glass tube towards the elevated magnetic object. The degree of sustaining the magnetic object elevation above the repelling electromagnet at the bottom of the glass tube is dependent upon the energy required to provide the amount of work and the number of Telsa required by the electromagnet at the bottom of the glass tube to sustain the elevated magnetic object.

The word flying is defined as moving or capable of moving in air. Considering the information in the above two paragraphs, the magnetic object may be elevated and manipulated as in flying in at least two ways. Because the elevated magnetic object is elevated and manipulated above the electromagnet located at the bottom of the glass tube, and the elevated magnetic object is not connected permanently or temporarily to the bottom electromagnet or to the glass tube, the elevated and manipulated magnetic object is manipulated as in flying. The inner walls of the glass tube and the inner diameter of the glass tube, in conjunction and similarity to the diameter of the elevated magnetic object keep the elevated magnetic object directly and vertically over the surface of the bottom electromagnet and hence direct repelling electromagnetic field force and pressure. The inner walls of the glass tube in conjunction with the width of the outer edges of the elevated magnetic object and the closeness of the outer edges of the elevated magnetic object to the inner walls of the glass tube, restrict the flipping of the elevated magnetic object while elevated and manipulated. The elevation and manipulation of the magnetic object as in flying may also be demonstrated if the elevated and manipulated magnetic object has much smaller diameters than the diameter of the inner glass tube walls (two inches for example) and the magnetic object has an additional mass connected to it, hanging downward from the magnetic object as to contribute to the stability and flipping reduction of the magnetic object during elevation; appropriate positioning of the center of mass. The additional mass may also have a light-weight ring attached to its lower end with a diameter similar to and less than the diameter of the inner glass tube walls (three and seven eight inches, for example). Again, the elevated and manipulated magnetic object is not permanently or temporarily connected to the glass tube or bottom electromagnet and hence is elevated and manipulated as in flying.

The word fly is also defined as ‘to cause to float in air’. The present invention includes the elevation, manipulation and elevation maintaining of an object above a bottom elevating electromagnet. As the elevation of the object is maintained, the object floats above the bottom elevating electromagnet. Hence the object in the present invention is elevated and manipulated as in flying.

The magnetic object may control its own elevation and manipulation when the elevated and manipulated magnetic object described in the experiment above is an electromagnet. The repelling force of the electromagnet at the bottom of the glass tube on the elevated electromagnet is directly affected by the repelling force of the elevated electromagnetic object. Increasing the repelling force of the elevated electromagnet contributes to the overall repulsion between the two electromagnets and hence the distance between the electromagnets may be increased. In addition, when the force of the electromagnet at the bottom of the glass tube is held constant, the electromagnetic force of the elevated electromagnet may be varied and the distance between the two electromagnets may be varied, including increased. Hence, the elevated electromagnet controls its own elevation. The elevated electromagnetic object may be repelled by an electromagnetic field acting on the object at an angle of ninety degrees relative to the surface of the elevated electromagnetic object (as shown in FIGS. 2 and 3) or at different angles relative to the surface of the elevated object (as shown in FIGS. 1 and 4). The elevated electromagnetic object may also be repelled by an electromagnetic force (i.e. a third, hand-held or mechanically operated electromagnet, or an electromagnet positioned on the outer wall of the glass tube) applied one hundred and eighty degrees relative to the surface of the elevated electromagnetic object. Increasing the repelling force of the elevated electromagnet contributes to the overall repulsion between the elevated electromagnet and the third electromagnet and hence the distance between these two electromagnets may be increased. In addition, when the force of the third electromagnet on the outer wall of the glass tube is held constant, the electromagnetic force of the elevated electromagnet may be varied and the distance between the two electromagnets may be varied. Hence, the elevated electromagnet controls its own elevation.

The elevated electromagnetic object controls its own manipulation when a smaller electromagnet is connected to, or attached to the top of the elevated electromagnetic object with the direction of the smaller electromagnet's repelling electromagnet field is at a 90 degree angle relative to the direction of the repelling electromagnetic fields of the electromagnet at the bottom of the glass tube and the elevated electromagnetic object. The electromagnetic field of the smaller electromagnet attached to the elevated electromagnetic object should be directed towards the electromagnet positioned on the outside wall of the glass tube and at a level with the maximum elevated object height. At any height, and with the electromagnetic force of both the electromagnet at the bottom of the glass tube and the electromagnet positioned outside the glass tube are held constant, the elevated electromagnetic object may control its own manipulation by varying the electromagnetic force of the smaller electromagnetic attached to the elevated electromagnetic. Increasing the electromagnetic field force of the smaller attached electromagnet in the direction of the repelling electromagnet positioned on the outside wall of the glass tube will increase the repulsion between the two electromagnets and hence increase the distance of the elevated electromagnetic object from the electromagnetic on the outer wall of the glass tube.

The electromagnet that is to be elevated may be positioned at an angle or tilted on one side relative to the surface of the bottom electromagnet and may still be repelled and hence elevated by the bottom electromagnet. A third electromagnet may be positioned on the outside wall of the glass tube at the maximum elevated magnetic object height (i.e. as elevated by the electromagnet at the bottom of the glass tube) and turned on during the elevation of the object. When the elevated electromagnetic object is at the maximum elevated height, the repelling force of the elevated object may be increased. Since the electromagnetic field of the elevated is facing the third electromagnet that is positioned on the outside of the glass tube, increasing the electromagnet force of the elevated electromagnetic object will cause the repelling force between the elevated electromagnet object and the third electromagnet positioned on the outside wall of the glass tube to increase and hence the distance between the two repelling electromagnets will increase. The elevated object controls its own manipulation while elevated.

Non-Vertically Constrained or Restricted, Non-Near-Ground Non-Near-Surface High Elevation and Sustained Elevation: Considering a round bottom glass tube with a bottom that allows vertical stability and also allows somewhat easily tilting or wobbling by horizontal force applied to the glass tube. Electromagnets M1 and M2 have the same polarity, and are facing each other in the glass tube.

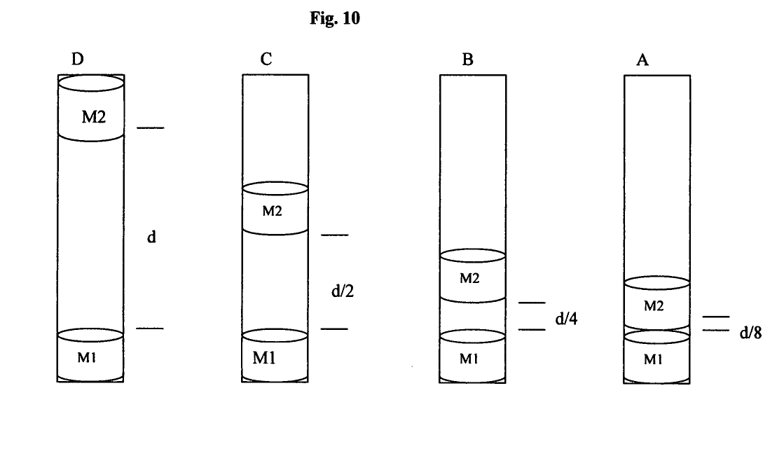

Magnets M1 and M2, having the same polarity, are positioned freely and facing each other in a glass or inert tube. See FIG. 10. M1 and M2 are electromagnets and may be powered by external or internal power sources. Because the electromagnet repelling force, work, and power of an electromagnet may be varied and controlled, both M1 and M2 may exert various degrees of repelling force towards each other. Depending on the size of M1 and M2, varying the repelling forces of both of the electromagnets causes the distance between the two repelling electromagnets to also vary. M1, which is the object being elevated, and M2 are emitting and receiving various degrees of electromagnet field energy regarding each other as the repulsion occurs. As the two electromagnets repel each other, both M1 and M2 are receiving repulsive forces from each other and both M1 and M2 are also emitting electromagnetic forces towards each other. Diagram A shows M1 and M2 separated by a distance of d/8 with an appropriate repelling forces between the two electromagnets. Doubling (i.e. very large powerful electromagnet below a smaller electromagnet, and an upward repelling force capable of doubling the distance between the two electromagnets) the repelling forces (i.e. F, W, P, or E of either or both M1 & M2) between M1 and M2 results in a distance of d/4 between the two electromagnets as shown in diagram B. Again doubling the repelling force between M1 and M2 results in a distance of d/2 between the two electromagnets. Again doubling the repelling forces between M1 and M2 results in a distance of d between the two electromagnets.

The electromagnets and objects may be circular or other shaped, DC or AC powered electromagnets with varying voltages, with top, bottom, or other wire outlets, copper wound coils, steel (or other lightweight material) case, appropriate insulation throughout, and continuous or non-continuous duty type. The elevated object may be a single electromagnet (i.e. an electromagnet only or an electromagnet attached to an object being elevated) or the elevated object may include multiple magnets as a single unit including a cube/circular shaped object with electromagnets spaced evenly on six sides of object.

The force/energy needed to move M2 vertically to any of the distances (d) shown above is

F_{netΔx}=½ mv²−½ mv₀²

where x is the distance M2 moves. For a person with a mass of 100 Kg (i.e. the mass of the person sitting on top of the magnet M2 including the mass of the person and the magnet) to be elevated or repelled vertically to distance of 1 meter with a velocity of 1 m/s,

$${F}_{net Δ x} = 1 / 2 ( 100 Kg ) {( 1 m \text{/} s )}^{2} - 1 / 2 ( 100 Kg ) {( 0 m \text{/} s )}^{2}$$

$${F}_{net Δ x} = 50 Kg \frac{{m}^{2}}{{s}^{2}}$$

This is also the force/energy needed by M1 to repel and elevate M2 to a distance of 1 m, F_{M1Δx}. Since F=ma, the force of a 50 Kg M2 elevating 1 M at 1 m/s for 1 s is 50 Kg*M/s².

The amount of work, W, by M1 in elevating M2 1 M is

$$W = F * d * cos θ$$

$${W}_{M 1} = ( 50 Kg \frac{m}{{s}^{2}} ) ( 1 m ) ( cos 0 )$$

$${W}_{M 1} = 50 Kg \frac{{m}^{2}}{{s}^{2}}$$

$${W}_{M 1} = 50 Nm$$

$$note that 1 Joule = ( 1 N ) ( 1 m )$$

The power, P, to sustain W for a given time, is

P=W/Δt

To sustain M2 at 1 meter for 1,000 seconds, s (16.7 minutes) P is

P_{M1}=(50 Nm)/(1,000 s)=0.05 N*m/s or 0.05 J/s where J is joules.

Since 1 J=(1 TCm/s)*m, P_{M2}=0.05 (TCm/s)*m/s where T is Telsa, C is Coulombs, m is meters, and s is seconds.

For a 300,000 lb. space shuttle, (M2),

F_{M2Δx}=68.04 Kgm/s²,

W_{M2}=68.04 (Kgm²/s²)(m)=68.04 Nm

P_{M2}=(68.04 Nm)*(1,000 s)=68.04×10³ N*m/s or 68.04×10³ J/s or 68.04×10³ (TCm/s*m)/s

For a smaller person of 10 Kg and of a distance of 10 m and a velocity of (10 m)/(10 s)

$${F}_{net Δ x} = 1 / 2 ( 10 Kg ) {( 1 m \text{/} s )}^{2} - 1 / 2 ( 10 Kg ) {( 0 m \text{/} s )}^{2} 2$$

$${F}_{net Δ x} = 5 Kg \frac{{m}^{2}}{{s}^{2}}$$

This is also the force/energy needed by M1 to repel and elevate M2 to a distance of 1 m, F_{M1Δx}. Since F=ma, the force of a 10 Kg M2 elevating 10 M at 10 m/s for 10 s is 10 Kg*M/s².

The amount of work, W, by M1 in elevating M2 associated with F_{M1Δx}

$$W = F * d * cos θ$$

$${W}_{M 1} = ( 10 Kg \frac{m}{{s}^{2}} ) ( 1 m ) ( cos 0 )$$

$${W}_{M 1} = 10 Kg \frac{{m}^{2}}{{s}^{2}}$$

$${W}_{M 1} = 10 Nm$$

$$note that 1 Joule = ( 1 N ) ( 1 m )$$

The power, P, associated with sustaining W over time, W_{M1}, is

P=W/Δt

To sustain M2 at 1 M for 1,000 seconds, s (16.7 minutes) P is

P_{M1=(}10 Nm)/(1,000 s)=0.01 N*m/s or 0.01 J/s where J is joules.

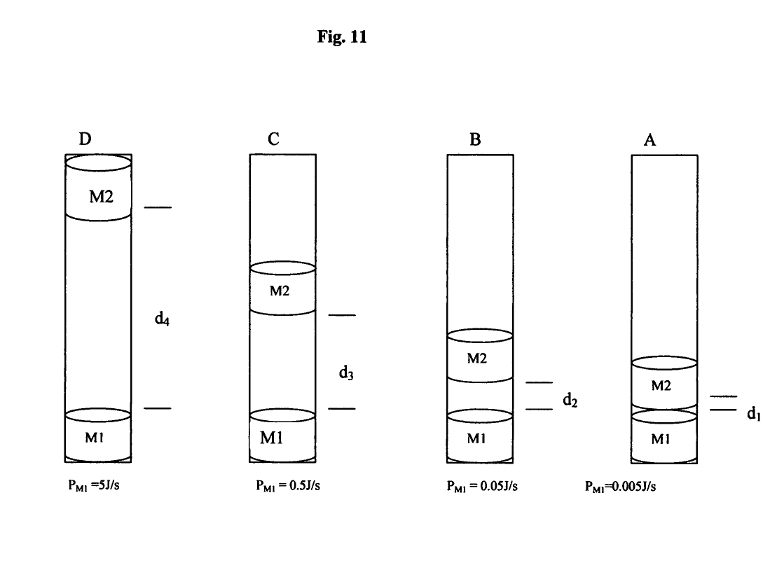

Varying the power of electromagnet M1 causes variation in the vertical elevation of M2. See FIG. 11. The elevation is vertically unconfined and unrestricted high and large upward extension, non-near-ground or non-near-elevating-surface or far-above-ground or -surface. Since 1 J=(1 TCm/s)*m, P_{M2}=0.05 (TCm/s)*m/s where T is Telsa, C is Coulombs, m is meters, and s is seconds.

Prior art and referenced documentation claim, describe, and show the object in transport as very-near- and near-elevating-surface type transportation relative to the surface(s) of the repelling or elevating electromagnets as opposed to the present invention which claims, describes, and shows the object in transport as high and large upward extension and non-vertically restricted or constrained non-near-ground or non-near-elevating-surface or far-above-ground or far-above-elevating-surface transportation relative to the surface(s) of the repelling or elevating electromagnets.

Electromagnets exist that produce fields of 50 T to 850 T as referenced in my earlier communications.

The present invention is not meant to lift the space shuttle, because of its mass and other considerations, all the way into space. Instead, it is intended to contribute to the lift of the space shuttle towards space; considered as flight. The present invention is not necessarily meant to lift shuttles, aircraft, or other object to a maximum elevation or flight heights, but instead to relatively high elevation and flight heights.

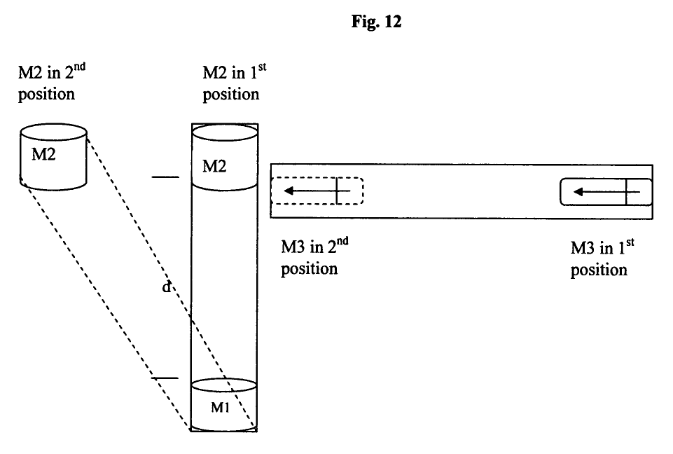

Considering the required forces for the manipulation of the elevated objects, consider the following, including electromagnets M1 (elevating electromagnet), M2 (elevated object) and a third electromagnet M3 (to push the elevated M2), magnets M1 and M2, positioned freely in a glass or inert round-bottom tube, with M2 repelled (and unconfined unrestricted high and large upward extension, non-near-ground or -surface or far-above-ground or -surface elevated) by M1 to the 1^{st} position, see FIG. 12. Magnet M3 repels magnet M2 (as M2 is unconfined unrestricted high and large upward extension, non-near-ground or -surface or far-above-ground or -surface elevated by M1). Magnet M2 is therefore levitated (and multi- and all-directional unconfined nonguided unrestricted non-motorized and long distance multi-directionally) manipulated by Magnets M1 and M3.

Electromagnets M1, M2, and M3 have the same polarities and repel each other when appropriately positioned (same polarities facing each other, or able to affect repelling electromagnetic forces on each other, and therefore repelling each other). Once M2 is elevated and sustained in 1^{st} position above by the electromagnetic repulsion of M1, then M3, which may be in a stable position at any desired height (3 meters for example) and in close proximity to M2, M3 may then electromagnetically repel M2 horizontally to 2^{nd} position. The elevated object M2 is hence manipulated by M3 as in flying. Electromagnet M3 may be positioned in a stable manner on a wall or other surface as shown above and the glass tube is positioned near (0.5 cm for example) the wall or other surface. M3 does not necessarily have to be extended from the wall as shown and may be positioned directly on the wall, etc. Electromagnet M3 is positioned at the height at which M2 will be elevated by M1 within the glass tube. Once M2 is elevated and the elevation is sustained by M1 at in the first position, electromagnet M3 can then be turned on, and repels M2 away from M3 horizontally causing M2 to be repelled while elevated and hence manipulated. Similar calculations for M1 repelling M2 can be used for calculating the repelling force, work, and power etc, for M3 acting horizontally on M2 and for moving M2 from position 1 to position 2 for a given distance x.

Regarding the elevated object controlling its own manipulation, and considering the above paragraph, once M2 is elevated in the glass tube by M1 and sustained in 1^{st} position which is at the same height of the stably positioned M3 and very near (0.5 cm for example) M3, with M3 remaining stable, the electromagnetic repelling force of M2 may be increased and exerted towards or as to affect and therefore create repulsive forces between M2 and M3. Note that the elevated object, M2, may be made in a spherical/cube manner with six sides and one electromagnet outward facing on each of the six sides of the elevated object. Because M3 is remaining stable, and M2 is elevated in the rockable or tiltable glass tube, the electromagnet repulsive force of M2 acting on M3 may be increased, M2 will force itself away (i.e. repel itself) from the stably positioned M3 and hence is controlling its own manipulation. Because M2 may be repelled and elevated by M1 to various heights, as the position of M3 remains constant, M2 may force itself away from stationary M3 at various heights and therefore from various angles, and hence M2 may control its own manipulation in various directions relative to the stationary M3.

The elevation of the object in the present invention is sustained by continuing the repelling power of the repelling elevating electromagnet over a period of time when the object has reached a desired height. As shown in the above descriptions, the object may be elevated within the glass tube and the height of the object may be maintained by the repelling elevating electromagnet. The calculations of the required electromagnet forces, work, and power are shown above.

M3 may be positioned at various different stationary positions including any position along an x, y, and z axis relative to the position of elevated electromagnet/object M2 and exert electromagnetic repulsive forces on M2. Hence, the elevated object, M2 may be manipulated in various different directions, depending on the position of the third electromagnet M3, as in flying. In addition, multiple electromagnets like M3 may also be positioned at various heights to repel elevated M2. In this sense, the object, M2 is being manipulated by M3 and any other electromagnets position to repel M2 while it is elevated by M1. For any of the repulsive forces for one electromagnet acing on another, F, W, and P may be calculated as described above.

An object that is flying does not have to fly at very high altitudes only. Objects may fly at heights or altitudes of several meters above the ground or surface, or even at heights or altitudes of several centimeters as long as the height or altitude is maintained above ground or surface and the object moves in a particular direction while elevated at a given height or altitude.

Near-surface or near-ground elevation, transportation, and flying in all prior patents and documentation referenced in your communication are different from the present patent which includes objects flying at much greater distances above or away from the elevating electromagnet. The present invention is not for near- or very near-surface or near-ground or near-elevating-surface elevation, transportation and flying.

In prior art and documentation referenced in your communication, the horizontal movement is necessary and required to contribute directly to the vertical positioning of the elevating, moving, or flying object. The present invention, as opposed to the prior art and the documents provided by your office, describes vertical positioning of the elevated object that is in no way dependent upon the horizontal movement of the object.

The present invention includes unconfined unrestricted high and large upward extension, non-near-ground or non-near-elevating-surface or far-above-ground or -surface object elevation (ground being the position or location of the repelling electromagnet and surface being the repelling electromagnet surface) and multi-directional unconfined non-guided unrestricted non-motorized and long distance multidirectional manipulation. This description of “elevation” and “manipulation” in the present invention is different from the description of the prior art. As quoted from Coffey, which includes restricted object elevation, “high-speed transportation at ground level”. Coffey also describes the vertical manipulation of the “suspension height” between a first and second electromagnet (one above and one below as shown in Coffey FIG. 1) only as opposed to the present invention which describes no electromagnet above the elevated object and a third electromagnet which manipulates the object horizontally or multi-directionally. Coffey's object elevation is described as restricted, confined, limited elevation. Coffey's FIG. 1 shows the vertical elevation restriction of the magnet (16) by the motor (20) and the support structure (12). In Coffey's FIG. 2 the force of the magnet (16) is dependent on the height of the coils (20).

Luvell describes attractive forces used to elevate an object(s). Luvell describes 1) attractive forces to vertically elevate the object and 2) repulsive and attractive forces to repel or attract the object as to move the object axially (manipulate the object . . . ). But Luvell's description of elevation is limited and restricted and confined by the height of the attractor (17 in FIG. 1 for example). Luvell's description of object repulsion and attraction (as in manipulating the object other than vertically only) is only for a string- or wire-suspended object. Considering vertical movement, the object in Luvell's description moves upward only due to attractive forces (opposed to the present invention) and moves downward only due to repulsive forces (opposed to the present invention). The present invention describes non-attractive means of object elevation. The present invention describes non-attractive forces to repel (or reducing repulsive forces allowing the objects to be closer together) the object as to move the object axially (manipulate the object . . . ). The elevation in the present invention is not limited restricted or confined by the height of an attractor or any physical or other structure. The present invention does not include the manipulation or axial movement of a string- or wire-suspended object. The present invention describes upward object repulsion. The present invention describes repulsive forces used to push non-string or -wire-suspended objects multi-directionally. Considering vertical movement, the present invention allows for downward movement of the object by reducing the amount of upward vertical repulsion. Luvell does not describe high-flying object upward elevation and manipulation. The present patent describes high-flying object upward vertical repulsion and multi- or all-directional pushing or manipulation of the elevated non-string- or non-wire-suspended object.

NASA's maglev is described as motorized near-ground and near-repelling near-elevating surface transport. The present invention includes non-motorized non-near-ground and non-near-repelling-elevating-surface object transport. Aircraft take-off is also described by maglev as occurring as the aircraft nears and leaves the end of the track and it can take off like an airplane and then switch to other conventional engines to continue to orbit.

The magnets used to repel and propel objects using basic magnets/electromagnets described by Eastern Illinois include “Magnets used in motors . . . electric starter motors . . . linear induction motors that propel modern rapid transit trains.” The propulsion or manipulation or pushing of the elevated object in the present invention is not linear-induction-motorized. The horizontal and other movement of the high-flying elevated object in the present invention is caused only by the electromagnet repulsive force of an elevated third electromagnet acting on the highly elevated object.

### DETAILED DESCRIPTION OF THE DRAWINGS/BEST MODE FOR CARRYING OUT THE INVENTION

FIGS. 1 through 7 show magnetic or electromagnetic field producing sources or devices. The fields may be of a magnetic or electromagnetic nature. The magnetic or electromagnetic fields produced by the field producing sources or devices move in a particular direction (hence, the phrase ‘vectors’ may be used to described the fields moving in a particular direction) as to cause the objects to move away from the source during the elevation process. The fields may also manipulate the objects in upward, downward, left or right direction, back and forth, or angular or circular directions along X, Y, or Z axes. The objects are of a field elevatable or manipulatable nature.

The field producing sources or devices shown in FIGS. 1 through 7 are representative of a magnetic or electromagnetic (or other) field producing source or device. A simple example of the field producing source or device is a large electromagnet. The electromagnet is positioned such that a second electromagnet, object 1 (or objects 2 or 3) in FIGS. 1 through 7, are positioned above the large electromagnet, and are repelled by the larger electromagnet or field producing source or device. The two electromagnets repel each other because the faces of the electromagnets with the same polarity face each other. Considering FIG. 2 and considering a) the direction of the electromagnetic field of each of electromagnets is in the direction of the polarity of the other electromagnet and b) the electromagnets are in close enough proximity to each other, electromagnets A and B will repel each other. At a distance of maximum repulsion by each of the two electromagnets, the distance between the two electromagnets (i.e. the maximum degree of elevation of Electromagnet B above Electromagnet A) will be ‘constant’ or maintained and Electromagnet B may be levitated.

In all of the drawings, the smaller electromagnets or objects are positioned as to be repelled in an upward direction. In FIG. 3, Electromagnet A, in a stationary position, is much larger or powerful than Electromagnet B, and may exert a greater repelling force on Electromagnet B than if both magnets were of the same size and power. The objects shown in FIGS. 1 through 14 may be electromagnets or may be equipped as to be repelled by an electromagnet of same or similar polarity. The electromagnetic field produced by the field producing sources or devices may be increased or decreased (or shielded or unshielded, respectively) in an effort to vary the effect of the large electromagnet on the second (above positioned) electromagnets or objects. By varying the effects of the large electromagnet on the second (above positioned) electromagnets or objects, the field producing sources or devices are capable of elevating one or more of the objects shown in FIGS. 1 through 14. The field producing sources or devices are equipped such that the produced fields are directed towards the field producing source of the objects. The objects shown in FIGS. 1 through 14 are equipped with materials or sources of similar or same magnetic or electromagnetic fields as the field producing sources or devices.

Considering the above descriptions, the field producing source(s) and device(s) are positioned as to exert its (or their) electromagnetic (or other) field on or towards the object(s) from and in varying directions. FIG. 4 shows a stationary field producing source or Electromagnet A exerting its electromagnetic field in the direction of the electromagnetic field of two objects or Electromagnets B and C. The field producing source exerts its electromagnetic field at a 35 degree angle from object 1 to the field producing source and to object 2. Multiple field producing sources or devices may be positioned as to exert their electromagnetic fields on or towards a single object from and in varying directions and in varying degrees; hence the elevated object(s) may be manipulated. As shown in FIGS. 5 and 6, the result of both Electromagnets A and C simultaneously exerting a magnetic field towards the magnetic field of Electromagnet B is the movement or repelling of Electromagnetic B from position 1 to position 2. The continuation of the electromagnetic fields of Electromagnets A and C acting on the electromagnetic field of object 1 (Electromagnet B) is depicted by dashed lines in FIGS. 5 and 6. As shown in FIG. 6, Electromagnet B itself may exert an electromagnetic field in the direction of the electromagnetic field of Electromagnet C as Electromagnet A exerts its magnetic field towards the electromagnetic field of Electromagnet B. This also results in the movement or repelling of object 1 or Electromagnet B from position 1 to position 2. FIG. 7 shows a stationary field producing source or device (Electromagnet A) positioned below the earth's surface exerting an electromagnetic field towards (i.e. in the direction of and in close enough proximity to) object 1 (Electromagnet B) and hence repelling object 1 in an upward direction. The thickness of the surface between the two electromagnets A and B in FIG. 7 may be viewed as ranging from infinitesimally small to very large.

Considering flight, the launch of the space shuttle for example, the field producing sources or devices shown in FIGS. 1 through 14 are also representative of launch pads. The launch pads are equipped with very powerful electromagnetic field strength. Considering the present invention and the space shuttle, which may be represented by objects 1, 2, and 3 in FIG. 1 and object 1 in FIG. 8, the bottom of the space shuttle (or other appropriate positions about the shuttle) is equipped with magnets or electromagnets having the same or similar polarity as the launch pad or field producing sources or devices.

FIG. 8 shows a very large or powerful stationary field producing source or device (Electromagnet A) exerting an electromagnetic field (in the direction of and in appropriate proximity to) towards the electromagnetic field exerted by object 1 (the space shuttle with two solid rocket boosters). The space shuttle is therefore repelled in the opposite direction of the stationary field producing source or device by the field producing source or device. Increasing the strength of the stationary field producing source or device and removing (or reducing the size of) the solid rocket boosters results in a greater repulsion of object 1 (space shuttle) by the field-producing source (Electromagnet A). With the power or strength of the field producing launch pad reduced or turned off, the space shuttle, which is equipped with magnets or electromagnets of the same polarity as the launch pad field producing source or device, may be placed above or on top of the launch pad. The power or strength of the electromagnetic field producing source or device may be increased and hence repel (or push up on) the space shuttle. The upward repelling of the space shuttle by the field producing source or device or launch pad contributes to the upward lift or push of the shuttle. Varying the strength of the magnetic field acting on the shuttle, varying the angle at which the electromagnetic field strikes or affects the shuttle, and varying the number of field producing sources or devices acting upon the shuttle allows the shuttle to be elevated and manipulated.

Considering flight, rotary-wing and non-rotary-wing flight for example, the field producing source or device shown in FIG. 9 is representative of the runway or launch pad. Five electromagnets (Electromagnets 1 through 5) are positioned just below the surface of the runway. The strength of the electromagnetic fields of the stationary electromagnets (Electromagnets 1 through 5) increase from left to right with Electromagnet 5 having the strongest electromagnetic field strength. As the aircraft (object 1 or Electromagnet E) moves down the runway over the stationary electromagnets from left to right, the repulsion between the stationary electromagnets and object 1 increases as the aircraft passes over Electromagnets A to D. Hence, the distance between the stationary electromagnets and object 1 increases as the aircraft moves down the runway. The runway or launch pad is equipped with very powerful magnetic or electromagnetic field strength. The field producing source or device in FIG. 9 represents a runway over which craft may take off. The length of the runway is equipped with magnetic or electromagnetic field producing sources or devices. Considering the present invention and rotary-wing or non-rotary-wing craft, which may be represented the objects in FIGS. 1 through 14, the bottom of the craft (or other appropriate positions about the craft) is equipped with magnets or electromagnets having the same or similar polarity as the runway positioned launch pad or field producing sources or devices. As rotary-wing or non-rotary-wing craft take off down the runway, the power or strength of the field producing sources or devices may be directed towards the craft as they take off. The runway positioned field producing sources or devices are positioned along the runway as the craft takes off. The power or strength of electromagnetic field producing sources or devices may be increased as the craft speeds down the runway and hence repel (or push up on) the craft and contributing to the lift of the craft. The upward repelling of the craft by the field producing sources or devices along the runway or launch pad contributes to the upward lift or push of the craft as it moves down the runway. Varying the strength of the electromagnetic field acting on the craft, varying the angle at which the electromagnetic field strikes or affects the craft, and varying the number of field producing sources or devices acting upon the craft allows the craft to be elevated and manipulated.

Considering the transport of persons or other objects or materials, driving, walking, or using elevators, the field producing sources or devices shown in FIGS. 1 through 7 are representative of a) the road surface in the case of driving, b) the sidewalk or other walking surface in the case of walking, or c) the lifting and lowering source in the elevator shaft beneath the elevator in the case of using elevators. The road surface, sidewalk, or lifting and lowering sources are equipped with very powerful magnetic or electromagnetic field producing sources or devices. Considering the present invention and road transportation, for which automotive or other vehicles may be represented by objects 1, 2, or 3 in FIGS. 1 through 14, the bottom of the vehicle (or other appropriate positions about the vehicle) is equipped with magnets or electromagnets having the same or similar polarity as the road surface positioned field producing sources or devices. With the power or strength of the field producing sources or devices turned off, the vehicle, person, or elevator, which is equipped with magnets or electromagnets of the same polarity as the road, sidewalk, or elevator lifting field producing sources or devices, may be placed above or on top of the field producing sources or devices. As the vehicle or person moves along the road or walkway, the power or strength of the magnetic or electromagnetic field producing sources or devices may be increased and hence repel (or push up on) the vehicle or person. The upward repelling of the vehicle or person by the field producing source or device contributes to the upward lift or push of the vehicle or person. Varying the strength of the magnetic or electromagnetic field acting on the vehicle or person, varying the angle at which the magnetic or electromagnetic field strikes or affects the vehicle or person, and varying the number of field producing sources or devices acting upon the vehicle or person allows the vehicle or person to be elevated or manipulated. As depicted in FIGS. 1 through 7 and 10 through 14, objects may be representative of an elevator with the field producing sources or devices pushing the elevator up the elevator shaft, elevating and maintaining the elevator at a desired position, or lowering the elevator to a desired position.

A very simple manner of making the present invention consists of placing an electromagnetic field producing device or source in a desired position, shielding the electromagnetic field with a thin shield, placing the object(s) just above the electromagnet or field producing device or on or above the thin shield (with same polarities facing each other), and progressively expose the object(s) to the electromagnetic field. Progressively opening covered holes (made throughout the thin shield) to expose varying strengths or degrees of the produced field to the objects will cause the object to move or be elevated above the field source and the thin shield. Optimally, the present invention is equipped with technological and other enhancements that will optimize the capabilities of the invention.

Each of the objects shown in FIGS. 1 to 14 are designed and equipped such that each may elevate and manipulate itself. Energy sources are provided for the electromagnets shown in FIGS. 1 to 14 and may be within or about the magnets or objects.

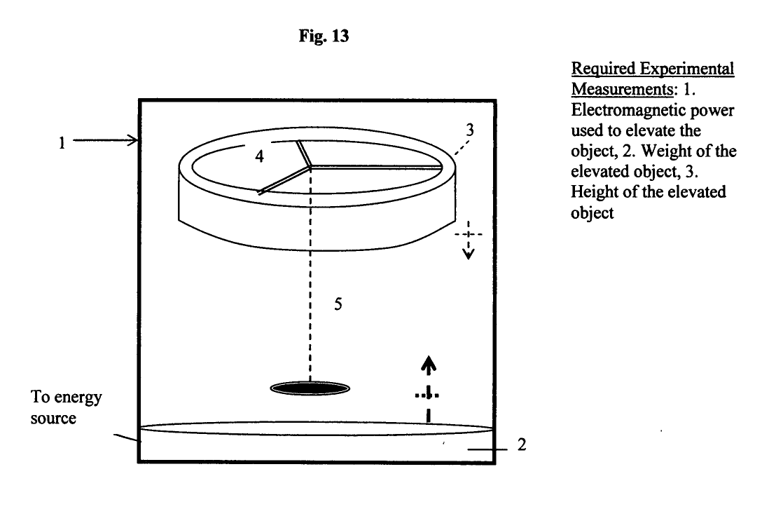

Description of the device includes an electromagnetic or magnetic unconfined unrestricted high and large upward extension, non-near-ground or -surface or far-above-ground or -surface object elevating device for non-flipping objects as shown in FIG. 13.

The following descriptions are associated with the ‘object to be elevated’ in FIG. 13. The initial dimensions and properties of the components of the device include the following information. The vertical length of the glass enclosure (1) is 2 feet (i.e. minus the depth or vertical length of the electromagnet (2) and the inside diameter of the glass enclosure is 4 inches. Component (5) must therefore be greater than 4 inches and will initially be 5 inches in length. Note that there is a maximum length of component (5) for which a) flipping of the elevated magnet (3) is minimized, b) the stability of the elevated magnet (3) is maximized, and c) the distance between the electromagnet (2) and the bottom of component (5) can be maximized.

Component (1) is a round or cylindrical glass see-through (plexiglass, plastic, or other material) enclosure (with or without a top cover) similar to a test tube with or without the bottom of the tube present. An electromagnet (2) or other magnet is positioned within the bottom of the enclosure such that the direction of the repelling electromagnet (2) or other magnet field towards the elevated magnet (3) is upwards or vertical and the field is within the enclosure. The glass enclosure (1) may be closed or capped at the top and should be of a length comparable to a) the repulsive strength of the electromagnet (2) and hence b) the repulsive force between the electromagnet (2) and the elevated magnet (3). The power of the electromagnet (2) and the repulsion between the electromagnet (2) and the magnet (3) should be such that the magnet (3) may be elevated approximately 2 feet above the surface of the electromagnet. The electromagnet (2) may be connected to an energy source if required or the magnet field may be self-generating. The electromagnet field may be controlled electronically, physically, or by other means.

Component (4) is a light-weight, triangular shaped (or other shaped) positioning component firmly connected to the elevated magnet (3) that holds component (5) in the center of the elevated magnet (3) in a strong, sturdy manner. Component (4) may be less than or equal in thickness to the elevated magnet (3). The size, shape, and mass of component (4) should allow maximum repulsive elevation and manipulation of the elevated magnet (3).

Component (5) is a light-weight, sturdy or rigid, material, extending downward from the center of the triangular shaped component. Component (5) is inert to the glass enclosure and has a round bottom. Component (5) may vary in shape, size, weight, and magnetic inertness. The round bottom should also be light-weight and may be made of rubbery or other material with minimum friction with the glass enclosure. The ‘round bottom’ may be spherical or circular in nature. The circular round bottom may be attached directly or indirectly to the bottom of component (5). The diameter of the circular round bottom may be up just short of the inside diameter of the glass enclosure and should be made to optimize the elevation and manipulation of the elevated magnet (3). The total length of component of (5) must be greater than the inside diameter (d) of the glass enclosure to the extent that as the magnet (3) ‘attempts’ to flip, the bottom of component (5) will touch the inside walls of the glass enclosure and prevent the magnet (3) from flipping. The greater the length of component (5) compared to the inside diameter (d) of the glass enclosure, the less will the magnet (3) flip when being repelled by the electromagnet. Regarding the efficiency of the process of elevating and manipulating the elevated magnet (3), the center of gravity of the three components of the entire elevated object including the magnet (3) component (5), and the triangular shaped positioning component (4), and the mass of the entire elevated object should be a) positioned for maximum flipping resistance and b) relatively small compared to the mass of the magnet (3), respectively. “Light-weight” is relative to the size and weight of the magnet (3) and to the repulsive force between the electromagnet (2) and the magnet (3). The elevated electromagnet (1) and electromagnet (2) are similar in properties and may be different in size or power.

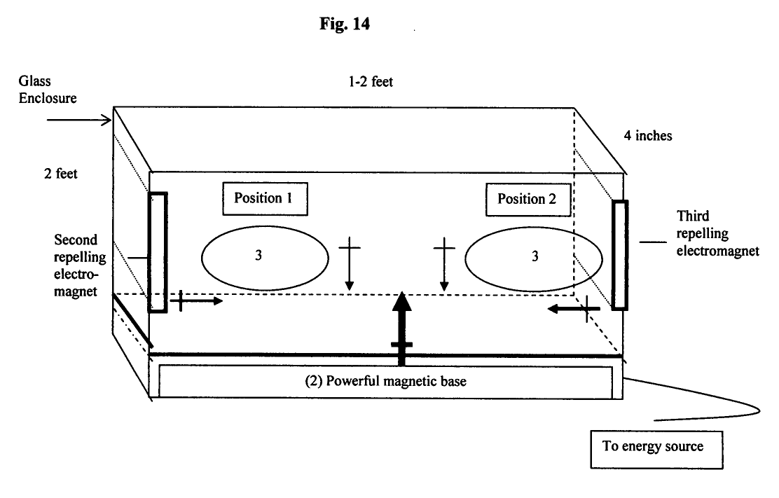

Magnetic unconfined unrestricted high and large upward extension, non-near-ground or -surface or far-above-ground or -surface object elevating and multi- and all-directional unconfined non-guided unrestricted non-motorized and long distance multidirectional manipulating device for non-flipping objects [elevated electromagnet or magnet (3) and components (4) and (5)] described in FIG. 14.

Electromagnets (3) and (2) are representative of the electromagnets (3) and (2) as shown in FIG. 14. Electromagnet (3) above is the object to be elevated. The diagram above is expanded version of the previous diagram. Electromagnet (3) is elevated and sustained in position 1 and the “second repelling electromagnet” may repel elevated electromagnet (3) from position 1 to position 2. The “third repelling electromagnet” may repel elevated electromagnet (3) from position 2 to position 1.

The present invention is intended to contribute to the thrust needed to lift the space shuttle (or other object) towards space as in flying and as opposed to lifting the space shuttle (or other object) all the way into space (as suggested/mentioned in your communication). The lift provided by the present invention may provide force enough to lift the shuttle (or other object) ranging from very small vertical distances (for very large masses) to larger distances (50 meters for example, for very small masses), but not necessarily all the way into space. The vertical height of object elevation is dependent upon the mass of the elevated and manipulated object and the force provided by the elevating and manipulating electromagnet.

The calculations shown above for calculating F, W, and P for M1 vertically repelling M2 to a distance of 1 m can also be used to calculate F, W, and P for vertically repelling M2 to varying elevated distances such as 0.1 m, 0.3 m, 0.9 m, 2 m, 10 m, or even higher distances. Regarding FIG. 9, electromagnets may be placed on a surface and the electromagnets may have the ability/power to vertically repel objects that pass in close vicinity of the electromagnets' repelling forces to 0.1 m, 0.3 m, 0.9 m, 2 m, 10 m, or even higher. As a small object (that may be repelled by the electromagnets on the surface) passes over, and near to the electromagnets (down a runway or other surface), the first electromagnet on the surface repels the object to a height of 0.1 m, as the object reaches the second electromagnet, the object is repelled to 0.3 m, as the object reaches the third electromagnet, the object is repelled to 0.9 m, as the object reaches the fourth electromagnet, the object is repelled to 2 m, and as the object reaches the fifth electromagnet, the object is repelled to 10 m. In the case of FIG. 9, and actual aircraft or a model or scaled-down model of an aircraft should be considered. The multiple electromagnets shown in FIG. 9 are on, or very near the ground or runway surface, and the multiple electromagnets effects the object being lifted only to distances ranging from 10⁻⁵ m to 10² m or so from the ground or surface. The affects of the electromagnets shown in FIG. 9 are intended to contribute to the lift and flight of the object or aircraft as opposed to lifting the object or aircraft all the way to very high altitudes or into space.

The different altitudes of the magnets shown in the flight-path in FIG. 9 are not maximum elevation or flight altitudes (thousands of feet for example) but rather refer to altitudes that may be a few meters or so for example.

One skilled in the art at the time of the invention would not use the electromagnets described by Coffey, Luvell, NASA, or Eastern Illinois (i.e. excluding the basic principles of magnets . . . ) to build the present invention or to move the object in the present invention in a desired direction.

What I claim as my invention is:

1. A high flying and large upward extension and non-vertically restricted or constrained non-near-ground or non-near-repelling-surface or far-above-ground or far-above-repelling-surface non-attractive vertical repelling and any-directional less-confined non-physically guided non-vertically-restricted less-horizontally-restricted non-motorized transport long distance non-attractive non-string- or wire-suspended pushing system comprising:
a first electromagnet used to vertically high flying non-vertically restricted non-limited non-confined non-near-ground or non-near-repelling-surface non-attractive upwardly non-string- or wire-suspended non-motorized-transport repel an object,
a third electromagnet used to multi-directionally unconfined-like nonguided-like unrestricted-like non-motorized-like non-linear-induction-motorized long distance non-attractive non-string- or wire-suspended non-near-repelling-surface non-motorized non-jet—rocket or -propeller-propelled repulsion-only push the upward vertically high-flying object.

2. The vertical repelling and multi-directional pushing system of claim 1, wherein the vertical repelling of the object may be sustained.

3. The vertical repelling and multi-directional pushing system of claim 2, wherein first electromagnet and the third electromagnet may be located at different angles and orientation with regard to the object.

4. The vertical repelling and multi-directional pushing system of claim 2, wherein the object may be vertically repelled and multi-directionally pushed as in flying.

5. The vertical repelling and multi-directional pushing system of claim 2, wherein the object may control its own vertical repulsion and multi-directional pushing.

6. The vertical repelling and multi-directional pushing system of claim 2, the first and third electromagnets and the object may receive or emit varying degrees of electromagnetic vertical repulsion or multi-directional pushing.

7. The vertical repelling and multi-directional pushing system of claim 2, wherein the object or the electromagnets may be on, below, above, or within the earth's surface.

8. The vertical repelling and multi-directional pushing system of claim 2, wherein the system may be comprised of multiple objects and multiple first and third electromagnets.

9. The vertical repelling and multi-directional pushing system of claim 2, wherein the object is an electromagnet.

10. The vertical repelling and multi-directional pushing system of claim 2, wherein the object is a magnet.

11. The vertical repelling and multi-directional pushing system of claim 2, wherein the system comprises at least one power source.

12. The vertical repelling and multi-directional pushing system of claim 2, wherein the object may be, or may be combined with animate and inanimate objects.
